(19) United States
(12) Patent Application Publication
(10) Pub. No.: US 2024/0199807 A1
(43) Pub. Date: Jun. 20, 2024

(54) Recyclable Epoxy-Anhydride Polymer

(71) Applicant: UT-Battelle, LLC, Oak Ridge, TN (US)

(72) Inventors: Amit K. NASKAR, Knoxville, TN (US); Jiho SEO, Buford, GA (US); Sargun Singh ROHEWAL, Knoxville, TN (US); Michael TOOMEY, Oak Ridge, TN (US); Logan T. KEARNEY, Knoxville, TN (US); Joshua T. DAMRON, Knoxville, TN (US)

(21) Appl. No.: 18/532,599

(22) Filed: Dec. 7, 2023

Related U.S. Application Data
(60) Provisional application No. 63/430,687, filed on Dec. 7, 2022.

(51) Int. Cl. C08G 65/26; C08K 5/00; C08K 11/00

(52) U.S. Cl. CPC C08G 65/2615; C08G 65/2642; C08K 5/00; C08K 11/005; C08K 2201/014

(57) ABSTRACT

A crosslinked polymeric composition comprising the following components: (i) a matrix comprising an epoxy-anhydride crosslinked polymer containing a multiplicity of ester linkages resulting from reaction between epoxy-containing and anhydride-containing molecules; and (ii) a hydroxy-containing solid filler component integrated into component (i) and engaged in dynamic reversible covalent crosslinking with component (i) by a reversible exchange reaction between the ester linkages and hydroxy groups in the hydroxy-containing solid filler; wherein the crosslinked polymeric composition behaves as a thermoset up to a temperature X and behaves as a processible thermoplastic at a temperature greater than X. Also described herein is a method for producing the above composition comprising combining and mixing the following components: (a) epoxy-containing molecules, (b) anhydride-containing molecules, (c) a hydroxy-containing solid filler, and (d) a catalyst that promotes curing between epoxy and anhydride groups, followed by heating of the resultant mixture to a temperature of least 100° C.

### CROSS REFERENCE TO RELATED APPLICATION

The present application claims benefit of U.S. Provisional Application No. 63/430,687, filed on Dec. 7, 2022, all of the contents of which are incorporated herein by reference.

### STATEMENT REGARDING FEDERALLY SPONSORED RESEARCH

This invention was made with government support under Prime Contract Nos. DE-AC05-00OR22725 and AC02-07CH11358 awarded by the U.S. Department of Energy. The government has certain rights in the invention.

### FIELD OF THE INVENTION

The present invention generally relates to epoxy polymeric compositions, and more particularly, to epoxy-anhydride polymeric and vitrimer polymer compositions.

### BACKGROUND

The majority of commodity and engineering plastics, both crosslinked thermoset and thermoplastic, used for versatile applications are manufactured from fossil and petro-chemical based building blocks that are very difficult to degrade and decompose. Moreover, most of the traditionally used plastics lack scalable recycling, repairing and reprocessing procedures which ultimately leads them to be either disposed of in a landfill or incinerated, thus having an adverse environmental effect. As various governing bodies around the world are pushing for legislation to phase-out single use plastics and promoting materials contributing to the circular economy, numerous researchers are working on designing thermosetting polymers with inherent recyclability.

Thermosetting polymers are extensively utilized in various applications due to their remarkable chemical resilience, stability and superior mechanical performance arising from their inherent permanently crosslinked network. Nevertheless, a primary challenge in thermoset materials, particularly those with low glass transition temperature (T_{g}), lies in the successful incorporation of robust networked structures to achieve reversible extensibility and toughness while preserving processability akin to thermoplastics. By convention, the inherent permanence of cross-linkages within thermoset materials constitutes a significant barrier to their processability using conventional methods (e.g., thermal shearing).

For applications, polymeric materials must exhibit robust performance over long durations. For example, at ambient condition, thermosetting high T_{g} polymer matrices must exhibit high stiffness and an ability to bear structural load. Likewise, soft elastomeric materials must exhibit steady reversible extensibility without decay in the networked structure. In both cases, networked structure plays a key role in achieving desired performance. Usually, these networked polymers are often reinforced by fibers or particulate to deliver polymer matrix composites with tailored stiffness, strength, or resistance to cyclic loading performance. However, manufacturing of such reinforced polymer matrix composites involves molding of a high viscosity charge that builds the networked structure during the molding, curing and/or crosslinking process. These finished composites have poor reprocessing and remanufacturing potential. Materials with reinforced performance coupled with excellent reprocessing potential are counterintuitive. The present invention addresses this challenge by selective application of dynamic covalent bonds in crosslinked networks of the polymer matrix.

Utilizing dynamic covalent bonds in crosslinked networks affords specific bond exchange mechanisms when exposed to external stimuli (e.g., light, heat, pH). The required temperatures for bond exchange often fall well below the degradation temperature of the polymer backbone, which enables the networked structures to be processed and reprocessed similarly to thermoplastics. Networked polymers structured with dynamic covalent linkages (also known as vitrimers) are reported here for high T_{g} recyclable polymers as suitable substitutes for industrial thermosets. Similarly, fast-relaxing, low T_{g}, networked yet recyclable rubber products are highlighted here as alternative to traditional vulcanizates or elastomers. It may be noted here that for rapid manufacturing of polymeric parts or components via resin transfer molding or injection molding, fast relaxing, exchangeable networks are desired. Faster relaxation allows shorter time for part manufacturing cycle without causing shrinkage induced defects. For a Maxwell viscoelastic fluid, the characteristic relaxation time, τ* is experimentally measured as the time required for a material to decay its initial applied stress value to 37% (1/e fraction). Materials with fast relaxation can maintain low viscosity.

A diverse array of chemical building blocks with functional groups are available that can be effectively exploited for facilitating dynamic covalent bonding that proceeds via transesterification. In this case, fillers containing excessive hydroxyl group are effective for enhancing the rate of bond-exchange via transesterification. In some cases, a catalyst is needed for the transesterification reaction to happen. Nonetheless, this mechanism can aid in designing materials compositions with high filler loadings to deliver robust performance at room temperature while achieving significant malleability or processability through hydroxyl-driven bond-exchange reactions, which in turn reduce the viscosity at elevated temperatures.

Applicable fillers and reinforcing phases with high surface hydroxyl group content span a wide range of categories including natural and synthetic materials in all relevant form factors including particles, fibers, platelets, nanofibers, etc. Examples of potential synthetic materials include, but are not limited to glasses and other ceramics, surface functionalized structural carbon, metals featuring surface oxides, and hydroxyl-containing polymers (e.g. polyvinyl alcohol, polyhydroxyalkanoates, polyurethanes, etc.). Natural materials (e.g. biomass) include but are not limited to the entirety of, or functional constituents of wood, corn stover, corn husks, switchgrass, miscanthus, bagasse, bamboo, alfalfa, paper or cellulose pulp, paper waste, nut hulls, bast, jute, flax, ramie, leaf, cotton, and hemp. As a subset of biomass materials functional elements obtained from waste food or residues from fruit cells or vegetables (e.g., coconut, nuts, coffee, etc.) may also be applicable.

### SUMMARY

The present disclosure is directed to epoxy-anhydride crosslinked polymers that behave as a thermoset up to a temperature X and as a processible thermoplastic at a temperature greater than X, wherein X is typically at or above 100° C. or 150° C., and typically up to or below 180° C. or 200° ° C. The polymers described herein advantageously include a hydroxy-containing solid filler, which may be biomass waste (e.g., SCG). More particularly, the polymers described herein include (or exclusively contain) the following components: (i) a matrix comprising an epoxy-anhydride crosslinked polymer containing a multiplicity of ester linkages resulting from reaction between epoxy-containing and anhydride-containing molecules; and (ii) a hydroxy-containing solid filler component integrated into component (i) and engaged in dynamic reversible covalent crosslinking with component (i) by a reversible exchange reaction between the ester linkages and hydroxy groups in the hydroxy-containing solid filler.

The present disclosure highlights the use of fillers or reinforcing agents enriched with surface hydroxyl groups that not only enable tailored stiffness and other mechanical properties at ambient condition but also offers rapid softening of the matrix via thermally triggered bond exchange reactions that facilitate thermal reprocessing, repairing, and remanufacturing of the part. The present disclosure addresses the challenge of designing materials with reinforced performance coupled with excellent processing, reprocessing, de-manufacturing, and remanufacturing potential while being suitable for a plethora of fillers and/or reinforcement phases.

This invention delivered translation of epoxy-anhydride thermoset polymer matrix to a vitrimeric compositions enabled by incorporation of hydroxyl group containing fillers such as glass fibers, cellulose, carbon fibers, wood flour, spent coffee ground (SCG), and lignin among other similar additives. The epoxy-anhydride thermoset may be prepared from epoxy functionalized molecules or macromolecules (e.g., rigid aromatic epoxy and soft epoxidized rubber or polyethylene glycol chain end capped with epoxy groups) with anhydride molecules (e.g., maleic anhydride, methyl nadic anhydride, etc.). Among the investigated hydroxyl group containing fillers, SCG is relatively less standard feedstock, which was collected from household waste. Specifically, SCG is the primary residue after the coffee brewing process, that has a lignocellulosic composition containing various organic compounds, such as hemicellulose (˜39%), lignin (˜24%), proteins (˜17%), cellulose (˜12%), and fatty acid (˜2%) (Ballesteros, L. F.; Teixeira, J. A.; Mussatto, S. I. Chemical, Functional, and Structural Properties of Spent Coffee Grounds and Coffee Silverskin. Food and Bioprocess Technology 2014, 7 (12), 3493-3503. DOI: 10.1007/s11947-014-1349-z).

In another aspect, the present disclosure is directed to a method for producing the above-described polymeric composition. The method entails combining and mixing the following components: (a) epoxy-containing molecules, (b) anhydride-containing molecules, (c) a hydroxy-containing solid filler, and (d) a catalyst that promotes curing between epoxy and anhydride groups, followed by heating of the resultant homogeneous or heterogeneous mixture to a temperature of at least 100° ° C. for a period of time that results in curing and formation of the crosslinked polymeric composition, wherein the crosslinked polymeric composition behaves as a thermoset up to a temperature X and behaves as a processible thermoplastic at a temperature greater than X, wherein X is typically at or above 100° C. or 150° C., and typically up to or below 180° C. or 200° ° C.

### BRIEF DESCRIPTION OF THE FIGURES

FIG. 1 (panels a, b, c). Schematic showing the overall curing steps for SCG/epoxy composites. Panel (a) shows low-viscous solution composed of bisphenol A diglycidyl ether (BADGE), poly(ethylene glycol) diglycidyl ether (PEGDGE), methyl nadic anhydride (MNA), and Zn(acac)₂; panel (b) shows SCG/epoxy slurry after mechanical mixing; and panel (c) shows SCG/epoxy slurry in a custom-made PTFE mold.

FIG. 2. Schematic showing the curing reaction of BADGE, PEGDGE, and MNA with a Zn(acac)₂ catalyst and the subsequent transesterification between ester groups of the epoxy-anhydride matrix and hydroxyl groups of the SCG fillers.

FIG. 3. FT-IR spectra of BADGE, PEGDGE, MNA, SCG, neat epoxy, and SCG/epoxy composites with various SCG contents up to 40% w/w.

FIG. 4. Graph showing the peak intensity ratio of hydroxy group at 3370 cm⁻¹ to ester group at 1740 cm⁻¹ as a function of SCG content in SCG/epoxy composites.

FIG. 5. Graph showing representative stress-strain curves for neat epoxy and SCG/epoxy composites with various SCG contents up to 40% w/w, obtained using unidirectional tensile testing.

FIG. 6. Graphs showing tensile strength, Young's modulus, and tensile strain at break of neat epoxy and SCG/epoxy composites with various SCG contents up to 40% w/w. Dashed lines are guides for eyes only to indicate the trends.

FIG. 7 (panels a-f). Photographs showing the surface of (a) neat SCG, (b) fractured neat epoxy, and (c-f) fractured SCG/epoxy composites with various SCG contents of 10, 20, 30, 40% w/w, respectively. The scale bar indicates 100 μm.

FIG. 8 (panels a-f). Graphs showing stress relaxations monitored from the normalized shear modulus for (a) neat epoxy and (b-e) SCG/epoxy composites with various SCG contents of 10, 20, 30, and 40% w/w, respectively, along with (f) the resultant characteristic relaxation time determined when the normalized shear modulus reaches

G(λ)/G₀=exp(−1)≅0.37.

FIG. 9. An Arrhenius plot to obtain the critical activation energy barrier to flow for neat epoxy and 10%, 20%, 30%, and 40% SCG compositions.

FIG. 10 (panels a and b). Graphs showing (a) heat flow from DSC and (b) normalized gap reduction by compression with 5 N from a rheometer on heating at 5 K/min for neat epoxy and SCG/epoxy composites with various SCG contents up to 40% w/w. The heat flow transition temperature and the onset of significant thickness drop are indicated by arrows. Solid lines are guides for eyes only to indicate the plateau.

FIG. 11. Demonstration of shape manipulation with 30% SCG/epoxy composite. Flat structures show the relaxed state after annealing at 150° C. for 3 minutes in an oven. Deformed structures show the altered state at room temperature after deforming the SCG/epoxy composite at 150° C. in various directions indicated by arrows.

FIG. 12 (panels a-c). (a) A planar design and (b) a photograph of the resultant three-dimensional cube structure made of 30% SCG/epoxy composite sheet. (c) Two nuts are placed on the cube structure to display the rigidity.

FIG. 13. Schematic representation of curing reaction between epoxy and cyclic anhydride group to yield ester based crosslinked network, which undergoes topological rearrangement via transesterification exchange reaction.

FIG. 14. Schematic diagram of fabrication procedure of cellulosic fiber scaffold (or paper) reinforced vitrimer composite.

FIG. 15. FTIR spectra of neat cellulose paper, neat vitrimer and cellulose scaffold (or paper)-reinforced vitrimer composite.

FIG. 16 (panels a-c). Thermal characterization of vitrimer composite: (a) TGA thermograms of neat cellulose paper, neat vitrimer and vitrimer matrix composite. DSC thermograms of (b) neat vitrimer and (c) vitrimer composite samples with different stoichiometric feed ratio of [epoxy]:[cyclic anhydride].

FIG. 17 (panels a-d). Mechanical characterization of vitrimer composites. Comparison of fracture strength of (a) neat vitrimer compositions and (b) neat cellulose paper and vitrimer composite (VC) with different stiochiometirc ratios of [epoxy]:[cyclic anhydride]. (c) Stress-strain curve of porous filter paper and paper-reinforced vitrimer composites. (d) Young's modulus of vitrimer paper composites.

FIG. 18 (panels a-b). Dynamic mechanical characterization of reinforced vitrimer composites: (a) Stress relaxation curves of Vitrimer 1:1 at different temperatures. (b) Stress relaxation curves of vitrimer and vitrimer-paper composites with different molar ratios at 250° C.

FIG. 19 (panels top and bottom). Time domain ¹H free induction decays (fid) of paper composite shown as a function of temperature (top panel) and fitted phase fractions from the fids (bottom panel).

FIG. 20. Phase fractions determined by ¹H time domain NMR for the pure vitrimer without cellulosic matrix. As shown, the onset of motion indicative of bond exchange starts to really shift at ˜125° C.

FIG. 21. Demonstration of reshaping and malleability of VC_{1:1} laminate at 150° C.

FIG. 22 (panels a-c). (a) Comparison of tensile testing results for VC laminates with different number of layers. (b) Stress-strain curves of VC_{1:1} laminate with different number of layers. (c) Images of laminate samples showing structural integrity of the sample and flexibility of thin composite vs. rigidity of multilayer laminates.

FIG. 23. Schematic preparation of acetonitrile-fractionated Kraft lignin (ACN-Lignin)/epoxidized natural rubber (ENR) vitrimer and its dynamic bonding through transesterification exchange reactions (TERs).

FIG. 24 (panels a-b). Graphs showing (a) dynamic mechanical loss tangent (tan delta) spectra and (b) DSC thermogram of Lignin-ENR25 vitrimer with different lignin content.

FIG. 25 (panels a-f). Dynamic mechanical characterization of ACN-Lignin/ENR25 vitrimer. Graphs (a-c) showing stress relaxation curves for (a) 60 phr and (b) 50 phr and (c) 40 phr ACN Lignin-ENR25 samples at different temperatures. (d) Stress relaxation curves of vitrimer with different lignin content at 200° ° C. (e) Fitting of the experimental relaxation times to the Arrhenius equation. (f) Characteristic relaxation times of ACN Lignin-ENR25 vitrimers with different lignin content at different temperatures.

FIG. 26 (panels a-f). Mechanical characterization of ACN-Lignin/ENR25 vitrimer: (a) stress-strain curves for ACN-Lignin/ENR25 vitrimer with different lignin loadings. (b) tensile toughness, proportionate to the area under the stress-strain curve. (c) storage modulus of ACN-Lignin/ENR25 vitrimer with different lignin loading as a function of temperature. (d) schematic representation of (re)processability of vitrimer samples. (e) stress-strain curves for 60-phr vitrimer sample for different reprocessing cycles at room temperature. (f) extension-retraction stress-strain curves for original and reprocessed 60 phr vitrimer samples with different loading cycles.

### DETAILED DESCRIPTION

In a first aspect, the present disclosure is directed to crosslinked polymeric compositions containing the following components: (i) a matrix comprising an epoxy-anhydride crosslinked polymer containing a multiplicity of ester linkages resulting from reaction between epoxy-containing and anhydride-containing molecules; and (ii) a hydroxy-containing solid filler (i.e., “filler”) component integrated into component (i) and engaged in dynamic reversible covalent crosslinking with component (i) by a reversible exchange reaction between the ester linkages and hydroxy groups in the hydroxy-containing solid filler. The filler can be integrated into the matrix homogeneously or heterogencously. The term “ester linkage,” as used herein, corresponds to linkages having the structure —OC(O)—. The ester linkages arise by the reaction of epoxy groups with anhydride groups, as is well known in the art.

The epoxy-containing molecules are typically organic molecules containing precisely or at least two epoxy groups (i.e., di-epoxy molecules), wherein the epoxy groups may be glycidyl groups. In some embodiments, the epoxy-containing molecules contain some rigidity by having phenylene rings in the molecules. In other embodiments, the epoxy-containing molecules contain some flexibility by having linear or branched alkylene or poly(alkyleneoxide) portions in the molecules. Some examples of di-epoxy organic molecules include bisphenol A diglycidyl ether (BADGE or DGEBA), glycidylated poly(ethylene glycol), 1,2,7,8-diepoxyoctane, 1,3-butadiene diepoxide, vanillin diepoxide, diglycidyl ether of hydroquinone, diglycidyl ether of resorcinol, diglycidyl ether of 1,4-benzenedimethanol, diglycidyl ether of terephthalic acid, eugenol diepoxide, diglycidyl ester of rosin acid, bisphenol F diglycidyl ether (BFDGE), diglycidyl ether derivatives containing spiro rings, and extended linear or branched resins of any of these containing two epoxy groups. The epoxy-containing molecules may also be or include tri-epoxy molecules. Some examples of tri-epoxy molecules include triglycidyl ether of phloroglucinol, triglycidyl ether of pyrogallol, triglycidyl ether of protocatechuic acid, triglycidyl ether of trimellitic acid, triglycidyl ether of vanillylamine, and tris(4-hydroxyphenyl)methane triglycidyl ether. The epoxy-containing molecules may also be or include tetra-epoxy molecules. Some examples of tetra-epoxy molecules include tetraglycidyl ether of gallic acid, pentaerythritol glycidyl ether, and tetraphenylolethane glycidyl ether. The epoxy-containing molecules may, in some embodiments, contain five, six, or more epoxy groups per molecule. For example, epoxidized derivatives of diene rubbers such as epoxidized cis polyisoprene (or epoxidized natural rubber) can be an epoxy-containing molecule. Other examples include epoxidized derivatives of unsaturated fatty acids, such as epoxidized soybean oil. In some embodiments, any one or more of the above classes or specific types of epoxy-containing molecules is/are excluded from the polymeric composition.

In some embodiments, the epoxy-containing molecules include a mixture of rigid (e.g., phenylene-containing or other ring-containing) and flexible (e.g., linear or branched alkylene or alkyleneoxide) epoxy-containing molecules. In some embodiments, the molar ratio between rigid and flexible epoxy-containing molecules is 5:1, 4:1, 3:1, 2:1, 1:1, 1:2, 1:3, 1:4, or 1:5, or a molar ratio within a range bounded by any two of the foregoing values, e.g., 5:1-1:5, 5:1-1:1, 4:1-1:4, or 4:1-1:1.

The anhydride-containing molecules are typically organic molecules containing precisely or at least two anhydride groups. The term “anhydride,” as used herein, refers to a group of the structure R—C(O)—O—C(O)—R′, as well known in the art, wherein R and R′ are hydrocarbon groups that may or may not be interconnected to form a ring. In particular embodiments, R and R′ interconnect to form a ring (i.e., the anhydride is cyclic). The anhydride-containing molecules may be monoanhydrides, dianhydrides, trianhydrides, or higher multiplicity anhydride molecules. Some examples of monoanhydride molecules include methyl nadic anhydride (MNA), tetrahydrophthalic anhydride (THPA), methyl tetrahydrophthalic anhydride (MTHPA), methylhexahydrophthalic anhydride MHHPA), maleic anhydride (MAH), and phthalic anhydride (PA), and mixtures of two or more of any of these. Some examples of dianhydride molecules include benzophenonetetracarboxylic dianhydride (BTDA), pyromellitic dianhydride (PMDA), 3,3′4,4′-biphenyltetracarboxylic acid dianhydride (BPDA), 4,4′-hexafluoroisopropylidenebisphthalic dianhydride (6FDA), 4,4′-oxydiphthalic anhydride (ODPA), 4,4′-(4,4′-isopropylidenediphenoxy)diphthalic anhydride (BPADA), and perylenetetracarboxylic dianhydride, and mixtures of two or more of any of these. In some embodiments, any one or more of the above classes or specific types of anhydride-containing molecules is/are excluded from the polymeric composition. In some embodiments, monocyclic anhydrides (e.g., MAH) or non-cyclic anhydrides (e.g., acetic anhydride) may be excluded. Notably, any of the above classes or specific types of anhydride-containing molecules (or mixture thereof) can be combined with any of the above classes or specific types of epoxy-containing molecules.

In some embodiments, the molar ratio between epoxy-containing molecules and anhydride-containing molecules (or alternatively, molar ratio between epoxy-containing groups and anhydride-containing groups) is 3:1, 2:1, 1:1, 1:2, or 1:3. The molar ratio may alternatively be within a range bounded by any two of the foregoing values, e.g., 3:1-1:3, 3:1-1:1, 2:1-1:2, or 2:1-1:1, or a molar ratio of about 1:1.

The hydroxy-containing solid filler component (i.e., “filler”) can be any solid particulate material known in the art that contains hydroxy groups. The filler may have an organic or inorganic composition. In some embodiments, the filler has an organic composition. In particular embodiments, the organic composition is a biomass composition, or more particularly, a biomass waste composition. The biomass waste may be, for example, food waste, such as spent coffee grounds (SCG). The biomass waste may also be agricultural waste. In some embodiments, the filler is or include lignocellulosic waste. Some examples of lignocellulosic waste includes wood, corn stover, corn husks, switchgrass, miscanthus, bagasse, bamboo, alfalfa, paper or cellulose pulp, paper waste, nut hulls, and hemp. In other embodiments, the filler is or includes lignin that has been substantially or completely separated from cellulosic matter. The lignin may be any of the types of lignin known in the art, including hardwood lignins, softwood lignins, grass-derived lignins, Kraft lignin, sulfite lignin (i.e., lignosulfonate), sulfur-free lignins (e.g., organosolv lignins), and engineered lignins. The lignin may also be crosslinked or uncrosslinked. In other embodiments, the filler has an inorganic composition, such as silica, alumina, or a metal oxide composition (e.g., zinc oxide, magnesium oxide, or titanium oxide). In specific embodiments, fillers are inorganic carbon based particles, fibers, nanofibers that are functionalized with hydroxyl groups. Fillers can also be glass fibers or microfibers. In specific embodiments, fillers are hydroxyl containing man-made or synthetic fibers from polyvinyl alcohol or high polyol containing polyurethane or polyester fibers. In some embodiments, any of the above classes or specific types of filler materials is/are excluded from the polymeric composition. The filler particles may be macroscopic in size (e.g., 1-100 microns), microscopic in size (e.g., at least 500 nm and less than 1 micron), or nanoscopic in size (e.g., at least 1, 2, 5, or 10 nm and up to or less than 100, 200, 300, 400, or 500 nm). Notably, any of the above classes or specific types of filler materials can be combined with any of the above classes or specific types of anhydride-containing molecules (or mixture thereof) which can be combined with any of the above classes or specific types of epoxy-containing molecules.

The filler is included in the polymeric composition in any suitable amount, typically at least or above 1 wt % and typically up to or less than 80 wt %. In different embodiments, the filler is included in the polymeric composition in an amount of precisely or about 1, 2, 5, 10, 15, 20, 25, 30, 35, 40, 45, 50, 55, 60, 65, 70, 75, or 80 wt % or an amount within a range bounded by any two of the foregoing values, e.g., 1-80 wt %, 2-80 wt %, 5-80 wt %, 10-80 wt %, 15-80 wt %, 20-80 wt %, 30-80 wt %, 40-80 wt %, 50-80 wt %, 1-50 wt %, 2-50 wt %, 5-50 wt %, 10-50 wt %, 15-50 wt %, 20-50 wt %, 1-40 wt %, 2-40 wt %, 5-40 wt %, 10-40 wt %, 15-40 wt %, 20-40 wt %, 1-30 wt %, 2-30 wt %, 5-30 wt %, 10-30 wt %, 15-30 wt %, 20-30 wt %, 1-20 wt %, 2-20 wt %, 5-20 wt %, 10-20 wt %, 15-20 wt %, 1-10 wt %, 2-10 wt %, or 5-10 wt %.

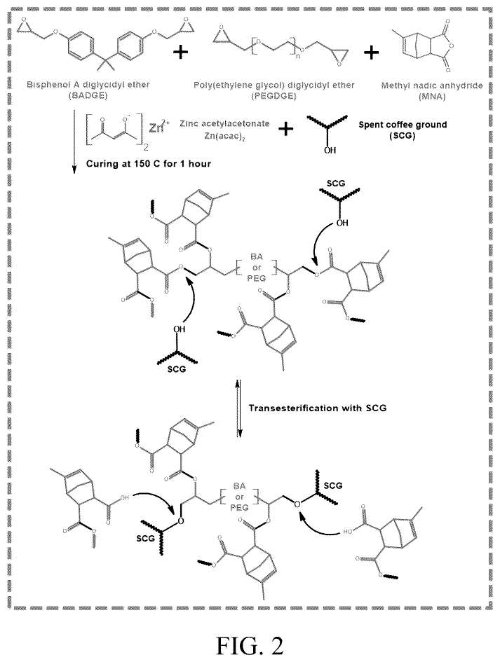

The filler described above is integrated into the component (i) matrix, typically homogeneously dispersed throughout component (i). However, in some embodiments, the filler may be integrated with component (i) in a heterogeneous manner, which may be evident in agglomerations of the filler particles. In some embodiments, such agglomerations are absent. The filler is engaged in dynamic reversible covalent crosslinking (which may be referred to as transesterification) with the component (i) matrix by a reversible exchange reaction between the ester linkages and hydroxy groups in the hydroxy-containing solid filler. The foregoing mechanism is shown in FIG. 2. By virtue of the dynamic reversible covalent crosslinking, the crosslinked polymeric composition behaves as a thermoset up to a temperature X and behaves as a processible thermoplastic at a temperature greater than X, wherein X is typically about, at least, or above 40, 50, 60, 70, 80, 90, 100, 110, 120, 130, 140, 150, 160, 170, 180, 190, or 200° C., or X may be within a range bounded by any two of the foregoing values (e.g., 50-200° C. or 50-150° C. or 50-100° C.).

The crosslinked polymer compositions can have a range of physical/mechanical properties (e.g., tensile strength, Young's modulus, and elongation at break) well suited for practical applications requiring strength, durability, and toughness. The tensile strength may be, for example, at least or greater than 5, 10, 20, 30, 40, 50, 60, 70, or 80 MPa. The modulus may be, for example, at least or greater than 1, 1.5, 2, 2.5, 3, 3.5, 4, or 5 GPa. The tensile strain at break may be, for example, about 1%, 1.1%, 1.2%, 1.3%, 1.4%, or 1.5%, or within a range bounded by any two of these values (e.g., 1-1.5%, 1.1-1.5%, 1.2-1.5%, or 1-1.2%). In specific polymer compositions the rubbery matrix exhibits elastomer-like behavior without requiring addition crosslinking agent. The rigid building block builds network structure in rubbery matrix at various range of loadings (e.g., 40-70 parts per 100 parts of rubber). Without additional reinforcing agent, the composition shows efficient shape recovery during cyclic loading and unloading. Those compositions have relatively low strength (4-15 MPa tensile strength) but with composition dependent broad range of extensibility with ultimate elongation from 8% to 1800%. Any of the foregoing values for different properties may be combined. Also, any of the values of physical properties provided above can be for any of the exemplary wt % of the filler or exemplary ranges thereof, such as described above.

Presence of fillers in a polymer matrix alters filler-matrix interactions and affects interfacial behavior—specifically, stress-relaxation rate that affects residual stress, warpage in molded part. In an unsuccessful reinforced composite, poor filler-matrix bonding allows faster stress-relaxation due to rupture of inefficient interfacial bonds under an applied stress that leads to accelerated stress relaxation. However, applicable composites that are structurally robust and possess strong interfacial bonding usually exhibit slower stress relaxation [U. Saced et al. Polym. Compos. 2014; 35:2159-2169]. These high-performance composites, however, often build residual stress and exhibit poor dimensional control in molded parts. These fillers in viscoelastic polymer generally slows the relaxation process, increasing the time constant. Furthermore, requirements of breaking the fiber-matrix interfacial bonds retards polymer mobility and relaxation. Stress relaxation in a composite is related to the time required to break the bonds and relax; therefore, it represents how quickly the polymer could become mobile again. Traditional composites, over time, incur damage of the intermolecular linking causing irreparable aging effects when the chains become mobile and intolerant to an applied stress. These drawbacks are addressed in this invention by employing interfacial bonding in robust composites that are also exchangeable exhibiting faster stress-relaxation via TERs at an elevated temperature. Faster stress relaxation (relaxation time ˜1-100 s) will not only allow rapid manufacturing without residual stress in molded parts, but also, repairability of aged parts via restoration of interfacial bonding through TER in aged parts. TER-induced interfacial reactions often induces enhancement of interfacial properties or phase compatibilization of multiphase polymeric products. Thus, these reinforced composites have potential to exhibit multiple functionalities such as self-healing, shape-memory and improved weldability with dissimilar surfaces enriched with hydroxyl groups.

In another aspect, the present disclosure is directed to a method of producing a crosslinked polymer composition as described above. In the method, the following components are first combined and mixed: (a) epoxy-containing molecules, (b) anhydride-containing molecules, (c) a hydroxy-containing solid filler, and (d) a catalyst that promotes curing between epoxy and anhydride groups. Components (a), (b), and (c) have been described in detail above and all such details are incorporated herein by reference. Component (d), the catalyst, may be any of the catalysts known in the art for promoting the reaction between epoxy and anhydride functional groups, such as, for example, zinc acetylacetonate, a tertiary amine, an imidazole, a quaternary ammonium salt, dicyandiamide, substituted urea, or any combination thereof. The mixing process is followed by heating of the resultant mixture to a temperature of precisely or least 100° C. (or, for example, precisely, at least, or above 120° C. or 150° C. or 200° ° C. or range therein) for a period of time (e.g., 20, 30, 40, 60, or 90 minutes) that results in curing and formation of the crosslinked polymeric composition. The optimal curing temperature is dependent on a number of factors, particularly the nature of the epoxy-containing molecules, anhydride-containing molecules, and the catalyst. The reaction is preferably conducted in the substantial absence of water. Thus, precautions may be taken to remove moisture from components before conducting the reaction. For example, the filler may be heat-treated to remove moisture. Precautions may also be taken to prevent uptake of moisture during the reaction, e.g., by conducting the reaction under a dried air or inert gas atmosphere.

In some embodiments, the mixture of epoxy-containing molecules and anhydride-containing molecules are impregnated into the hydroxy-containing solid filler component by a resin transfer molding process. In some embodiments, the resin transfer molding process is a vacuum assisted resin transfer molding process. The resin transfer process utilizes one or more reinforcing phases (in this case having hydroxyl-functionalities at the surface), most commonly in fiber form (as loose fiber, mats, fabrics, or preforms), a resin (in this case the mixed molecules that yield polymeric materials capable of dynamic covalent bond exchange), and a multi-component mold (usually a two-part mold). In many instances, a mold release agent is used to ensure easy removal of the molded part. In the process, the mold is loaded with the fiber reinforcement phase. Next, the dynamic covalent bonding polymer or its original precursor mixed molecules is heated to access its low viscosity flow behavior before injecting into the mold cavity containing the reinforcing phase. Once the mold cavity is completely filled, the mold and molded composite are allowed to cool until the thermoset behavior is reestablished. After reestablishing the thermoset performance, the mold is then disassembled, and the molded part is removed. The vacuum assisted resin transfer molding approach utilizes a mold (usually single-sided), a fiber reinforcement phase, a vacuum bag, and the dynamic covalent bonding polymer. In many instances, a mold release agent is used to ensure easy removal of the molded part. In the process, fiber reinforcement phase is added to the mold. Next, a vacuum bag is placed around the mold containing the fibers, and the edges of the bag are sealed to create an airtight enclosure. The design of the vacuum bag features strategically placed vacuum ports and vent lines which facilitate resin flow such that the mold is fully filled, and the fibers are fully wetted. Once the vacuum bag is sealed and secured, the dynamic covalent bonding polymer is heated to its low viscosity flow state before it is infused into the fiber layup by vacuum pressure. After fully infusing into the fiber and filling the mold, the mold and molded material are allowed to cool until the molded material's thermoset behavior is regained. Once the thermoset behavior is regained, the part is then removed from the vacuum bag and mold.

In another aspect, the present disclosure is directed to methods of producing an object made of the above-described crosslinked polymer by a molding process or additive manufacturing (AM) process. In the AM process, the above-described crosslinked polymer is used as a feed material in an AM device. The AM process can employ any of the AM devices well known in the art, such as a rapid prototyping unit, or more particularly a fused deposition modeling (FDM) or fused filament fabrication (FFF) device, or more particularly, a 3D printer. As well known in the art, the additive process generally operates by mixing and extruding a material through a die or nozzle of a suitable shape and repeatedly depositing discrete amounts (e.g., beads) of a melted or otherwise extrudable form of the feed material in designated locations to build a structure. The AM process typically employs an elevated temperature to melt and extrude the feed material through the die or nozzle of the AM device. The crosslinked polymeric composition described herein is typically melted and extruded at a temperature of at least or above 100° C. In different embodiments, dependent on the polymer composition, degree of crosslinking, and T_{g} of the crosslinked polymeric composition, the polymeric composition may be melted and extruded at a temperature of precisely or at least, for example, 100° C., 120° C., 150° C., 180° ° C., 200° ° C. or 220° C., or a temperature within a range bounded by any two of the foregoing values, e.g., 100-220° C. or 100-150° C. In the FFF or 3D printing process, the nozzle is moved in precise horizontal and vertical positions as beads of the feed material are deposited to ultimately form a solid object. Upon exiting the die (i.e., nozzle) in the additive processing unit, the extrudate cools and solidifies (hardens). The beads of feed material are sequentially deposited to build an object, layer by layer. The nozzle movements and flow rate of the feed material are generally controlled by computer software, typically a computer-aided manufacturing (CAM) software package. The FFF or 3D printer builds an object (article) based on instructions provided by a computer program that includes precise specifications of the object to be constructed.

The shape of the object that is ultimately built can be suited to any application in which a durable crosslinked material is desired. The shape of the object ultimately produced may be simple, e.g., a planar object, such as a film or coating of a desired two-dimensional shape (e.g., square or disc). Alternatively, the additive manufacturing process can be used to produce complex (i.e., intricate) shapes. Some examples of intricate shapes include rings, filled or unfilled tubes, filled or unfilled polygonal shapes having at least or more than four vertices, gears, and irregular (asymmetric) shapes.

Examples have been set forth below for the purpose of illustration and to describe certain specific embodiments of the invention. However, the scope of this invention is not to be in any way limited by the examples set forth herein.

### Example—I: Spent Coffee Ground Loaded Rigid Polyester-Based Epoxy Vitrimer

### Overview

Herein is described a malleable polyester-based epoxy vitrimer containing spent coffee grains (SCG) as a natural filler. Although the SCG/epoxy composite acted as a permanently crosslinked network at low temperatures, re-processing was successfully demonstrated at elevated temperatures through topological rearrangements driven by transesterification, which is the dynamic chain exchange reaction between the ester groups of epoxy matrix and the hydroxyl groups of SCG. Moreover, the formation of chemical linkages between epoxy matrix and SCG fillers through transesterification played a crucial role as a compatibilizer. There are increasing demands to recycle food waste to improve the global sustainability. These new findings provide a way to recycle coffee waste and other waste materials to convert them to functional materials while reducing environmental pollution.

More particularly, SCG, which is the primary residue after the brewing process, was recycled as a natural filler in a polyester-based epoxy matrix. A series of SCG/epoxy composites were evaluated with various SCG contents up to 40% w/w using FT-IR spectroscopy, tensile testing, optical microscopy, differential scanning calorimetry, and rheology. Although the polyester-based epoxy matrix retained a permanently crosslinked network showing outstanding dimensional stability, re-shaping was successfully demonstrated at high temperatures through transesterification which was driven by a dynamic chain exchange reaction between the ester group of epoxy matrix and the hydroxyl group of SCG fillers. Moreover, transesterification enhanced the interfacial adhesion between the epoxy matrix and SCG fillers, thus resulting in a practically sufficient tensile strength of >20 MPa and modulus of ˜2.5 GPa, even with high SCG contents up to 40% w/w.

### Materials

Bisphenol A diglycidyl ether (BADGE, CAS #1675-54-3), poly(ethylene glycol) diglycidyl ether (PEGDGE, CAS #26403-72-5), methyl nadic anhydride (MNA, CAS#25134-21-8), and zinc acetylacetonate (Zn(acac)₂, CAS #108503-47-5) were obtained commercially. The number average molecular weight of PEGDGE is reported to be Mn=500 g/mol from the manufacturer. Spent coffee ground (SCG) waste was collected from Starbucks Keurig® capsules (Italian Roast) after brewing coffee. To minimize moisture and volatile coffee oils, the SCG was dried at 80° C. overnight and subsequently treated at 150° C. for 1 hours in an oven.

### Preparation of SCG/Epoxy Composites

A polyester-based epoxy matrix was prepared by the chemical reaction of BADGE, PEGDGE, and MNA with a vitrimer catalyst of Zn(acac)₂ in a 1:1 stoichiometric ratio of epoxide and cyclic anhydride functional groups. BADGE imparted rigidity to the composite owing to its rigid aromatic structure. The role of PEGDGE was to improve the flexibility of the rigid BADGE-derived epoxy matrix so that the applied stress was transferred uniformly over the matrix under a load. The mechanical properties of various PEGDGE contents were evaluated in advance by tensile testing. The optimum molar ratio was determined to be BADGE:PEGDGE:MNA=0.8:0.2:2 that contains 30% w/w SCG fillers.

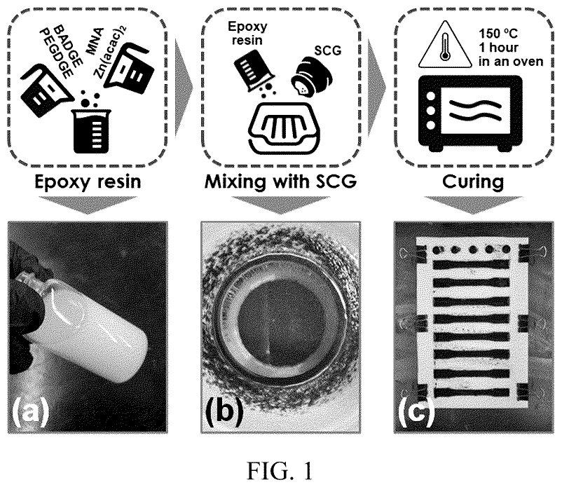

FIG. 1 schematically shows the overall curing steps to fabricate SCG/epoxy composites. The vitrimer catalyst of Zn(acac)₂ (5 mol % relative to the epoxy group) was dissolved in BADGE at 150° C. for 10 minutes in an oven and the BADGE/Zn(acac)₂ solution was subsequently mixed with PEGDGE and MNA at room temperature (typically about 20° C., 25° C., or)30° ° C.. Then, various weight fractions of SCG, varying at 10, 20, 30, and 40% w/w, were added into the low-viscous milky epoxy solution. When the weight fraction of SCG was higher than 40% w/w, the viscosity of SCG/epoxy slurry was too high to form a flat plate. The SCG/epoxy slurry was homogeneously mixed using a commercial mixer at 2000 revolutions per minute (2000 rpm) for 5 minutes at room temperature and transferred to a custom-made PTFE mold. The dimensions of the dumbbell-shaped tensile specimens in the PTFE mold follows ASTM D638 (Type I), but the thickness was controlled at ˜2 mm. To minimize air bubbles, the SCG/epoxy slurry in the PTFE mold was placed in a vacuum oven for 10 minutes at room temperature. Eventually, the SCG/epoxy slurry was cured at 150° C. for an hour in an oven. The thermal stability of raw materials was evaluated in advance using thermogravimetric analysis (TGA) on heating at 20° C./min from 30 to 1000° C. While MNA showed mild weight loss from 110° C. presumably due to the relatively low molecular weight, BADGE, PEGDGE, and SCG were thermally stable up to the curing temperature of 150° ° C. It is noted that the SCG/epoxy slurry was successfully cured even with the minor weight loss of MNA. All surfaces of cured SCG/epoxy composites were polished using a polishing device equipped with a 400 grit sandpaper under the force of 10 N for 3 minutes.

### Fourier-transform Infrared Spectroscopy (FT-IR)

The FT-IR spectra of BADGE, PEGDGE, MNA, Zn(acac)₂, neat epoxy, and SCG/epoxy composites were recorded to characterize the chemical structures. For each sample, 32 scans were carried out in the attenuated total reflectance (ATR) mode at room temperature over the wavenumber range from 4000 to 600 cm⁻¹, with the spectroscopic resolution of 4 cm⁻¹. All spectra were corrected against ambient air as the background.

### Tensile Testing

The mechanical properties of neat epoxy and SCG/epoxy composites were evaluated by uniaxial tensile tests. The stress evolution as a function of applied strain was monitored at a constant crosshead speed of 10 mm/min at room temperature using a tensile testing machine. Tensile strength, Young's modulus, and elongation at break were determined by averaging five data values with the standard deviation. Young's modulus was determined at the strain of ˜0.2%.

### Optical Microscopy

The surface of neat SCG, fractured epoxy, and fractured SCG/epoxy composites was examined using a VHX-2000 digital microscope equipped with a 500×objective lens in the reflection mode. All fractured samples were obtained from tensile testing.

### Rheology

All rheological measurements were performed using a DHR-3 rotational rheometer. For stress relaxation, shear modulus was monitored with time after instantly applying a shear strain of 0.01 for an hour at 240, 235, 230, 225, and 220° C. under a nitrogen atmosphere, using 8 mm stainless steel parallel plates. The equilibrium time of 5 minutes was allowed prior to running each stress relaxation. The shear modulus was normalized by the averaged modulus plateau in short times (<100s).

For constant-force-compression on heating, the sample thickness was monitored on heating at 10 K/min from 30 to 150° ° C. under a constant compression force of 5 N using an 8 mm stainless steel parallel plate and Peltier plate. The initial sample thickness was set to be ˜2 mm. The glass transition temperature was determined at the onset of glass-rubbery transition where the abrupt thickness reduction starts.

### Differential Scanning Calorimetry (DSC)

Thermal analysis was carried out with a differential scanning calorimeter and aluminum pans under nitrogen atmosphere at the flow rate of 50 m1/min. A relatively small amount of sample (˜5 mg) was prepared to minimize the thermal lag on heating. A couple of silicon oil drops were applied between the sample and aluminum pan to improve the thermal conductivity. The heat flow was monitored on the first heating at 10 K/min from −30 to 150° C. The glass transition temperature was determined at the middle point of heat flow transition.

### Malleability Testing

A 1-mm-thick sheet of 30% SCG/epoxy composite sheet was cut into an oak leaf and planar figure of cube structure, using a commercial water-jet cutter. Shape manipulation and origami were performed after softening the SCG/epoxy composite sheet at 150° C. All pictures were taken at room temperature.

### RESULTS

Curing Reaction of SCG/epoxy Composites

Polyester-based SCG/epoxy composites were prepared by classical epoxy/cyclic anhydride reaction in the presence of catalyst and SCG. For the sake of conceptualizing the intricate crosslinked network, FIG. 2 schematically depicts a straightforward case of full curing where two ester groups are generated on each MNA, linking to BADGE and PEGDGE. The rearrangement of crosslinked network through transesterification between the epoxy matrix and SCG fillers is depicted as well. Notably, although FIG. 2 indicates full curing, the process may be conducted with less than full curing. In some embodiments, the process is done with full curing. In other embodiments, the process is done with less than full curing, i.e., with partial curing.

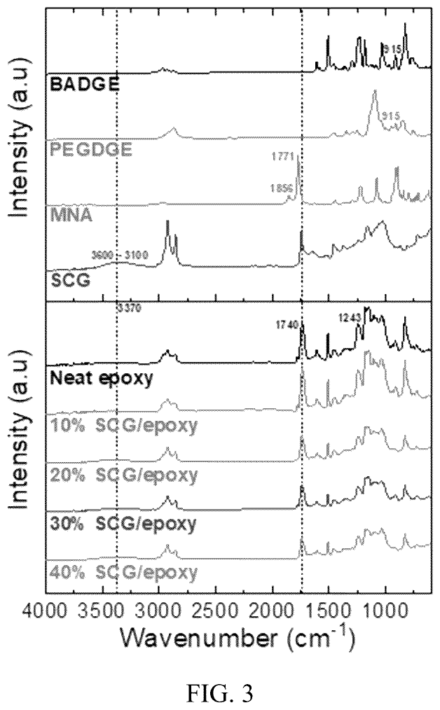

Although the curing mechanism of the epoxide/cyclic anhydride system is known to be complex, the overall chemical reactions are generally regarded as classical anionic ring-opening copolymerization (G. P. Kar et al., Journal of Materials Chemistry A 2020, 8 (45), 24137-24147. DOI: 10.1039/dOta07339c). For instance, the curing process can be initiated by a catalyst of Zn(acac)₂ at elevated temperatures, generating alkoxide intermediates from the epoxide of BADGE or PEGDGE. The alkoxide anion can subsequently react with the cyclic anhydride of MNA, producing carboxylate anion. Accordingly, recurring generations of the anion intermediates can propagate over the system, forming a polyester-based crosslinked network. It is noted that the epoxide/cyclic anhydride reaction yields only esters and no hydroxyl groups when the stoichiometric ratio of epoxide and cyclic anhydride is equal to one. Even though the epoxide/cyclic anhydride reaction is not susceptible to transesterification due to no generation of hydroxyl groups, the transesterification of SCG/epoxy composites was designed in this study by incorporating hydroxyl groups on the surface of SCG into the epoxy matrix. FT-IR analysis was conducted for all raw materials, neat epoxy, and SCG/epoxy composites to track the presence of functional groups. The FT-IR results are shown in FIG. 3.

Both BADGE and PEGDGE show the characteristic stretching vibration of the epoxide ring at 915 cm⁻¹, and MNA shows two symmetric and asymmetric C═O stretching peaks of cyclic anhydride at 1771 and 1856 cm⁻¹. The chemical reaction of epoxides with cyclic anhydrides was confirmed by the disappearance of two cyclic anhydride C═O stretching peaks and the emergence of two characteristic ester peaks in the FT-IR spectrum of neat epoxy: carbonyl C═O stretching at 1740 cm⁻¹ and ether C—O—C stretching at 1243 cm 1. Since SCG is a mixture of various organic compounds, the full characterization of functional groups was challenging. However, the presence of cellulose, hemicellulose, and lignin, which are major compounds accounting for ˜80% of SCG, can be identified from the following characteristic peaks: 811 (L), 872 (C), 1162 (C, H), 1240 (L), 1377 (C, H), 1460 (L), 1517 (L), 1655 (L), 1743 (H, L), 2853 (C, H, L), 2922 (C, H, L), and 3100-3600 cm⁻¹ (C, H, L), where C is cellulose, H is hemicellulose, and L is lignin (R. Musule et al., Journal of Wood Science 2016, 62 (6), 537-547. DOI: 10.1007/s10086-016-1585-0).

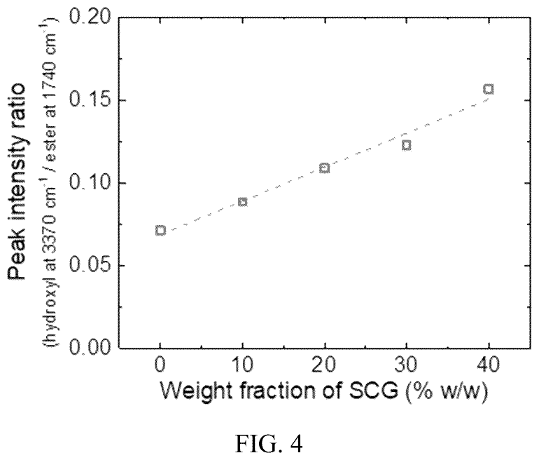

Transesterification is the displacement process of an alcohol from an ester by another alcohol often in the presence of a catalyst. Thus, the chain exchange reaction kinetics are governed by the number density of ester and hydroxyl groups in the system along with the type and concentration of catalyst. Assuming the epoxide/cyclic anhydride curing process yields abundant ester groups in the system without the generation of hydroxyl groups, the transesterification kinetics of SCG/epoxy composite are generally controlled by the amount of hydroxyl group contributed by SCG fillers. Hence, the quantity of the hydroxyl group relative to that of ester group is evaluated as a function of the SCG content, using the peak intensity ratio. The peak intensity ratios of hydroxy groups to ester groups as a function of SCG content in SCG/epoxy compositions is shown in FIG. 4. The peak intensity of hydroxyl groups was obtained at 3370 cm⁻¹ which is the middle point of a broad inter- and intra-molecular O—H stretching band from 3100 to 3600 cm⁻¹. The peak intensity of ester groups was obtained at 1740 cm⁻¹, which is attributed to carbonyl C═O stretching. The peak intensity ratio increases linearly as the weight fraction of SCG increases due to the addition of hydroxyl group on the surface of SCG. Higher transesterification kinetics with more SCG fillers were confirmed by stress relaxation.

### Mechanical Properties of SCG/epoxy Composites

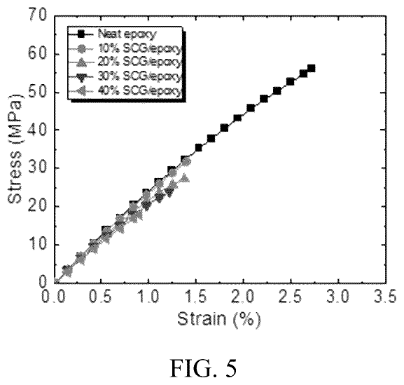

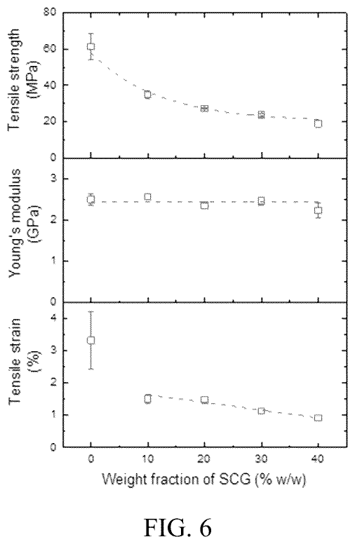

For a polymer composite containing natural fillers, the components are often thermodynamically non-compatible, resulting in poor mechanical properties. Thus, the evaluation of mechanical properties is practically important to determine recyclability of the natural fillers. FIG. 5 shows representative of stress-strain curves for neat epoxy and SCG/epoxy composites with various SCG contents up to 40% w/w, obtained using unidirectional tensile testing. The resultant tensile strength, Young's modulus, and tensile strain at break are presented in FIG. 6.

All neat epoxy and SCG/epoxy composites exhibited a brittle fracture without the yield point. To improve the mechanical performance of composite using fillers, the aspect ratio of filler is typically higher than 6 to induce preferential orientations. Since SCG particles used in this study were irregular in size with low aspect ratio, the tensile strength decayed exponentially with the SCG contents. However, the tensile strength empirically leveled off around 20 MPa with high SCG contents, yielding practically satisfactory performance. Moreover, the neat epoxy and SCG/epoxy composites showed a nearly constant Young's modulus of ˜2.5 GPa, independent of the weight fraction of SCG. The addition of SCG particles to the neat epoxy matrix abruptly dropped the tensile strain at break from ˜3 to ˜1.5%, and the tensile strain gradually decreased with the weight fraction of SCG.

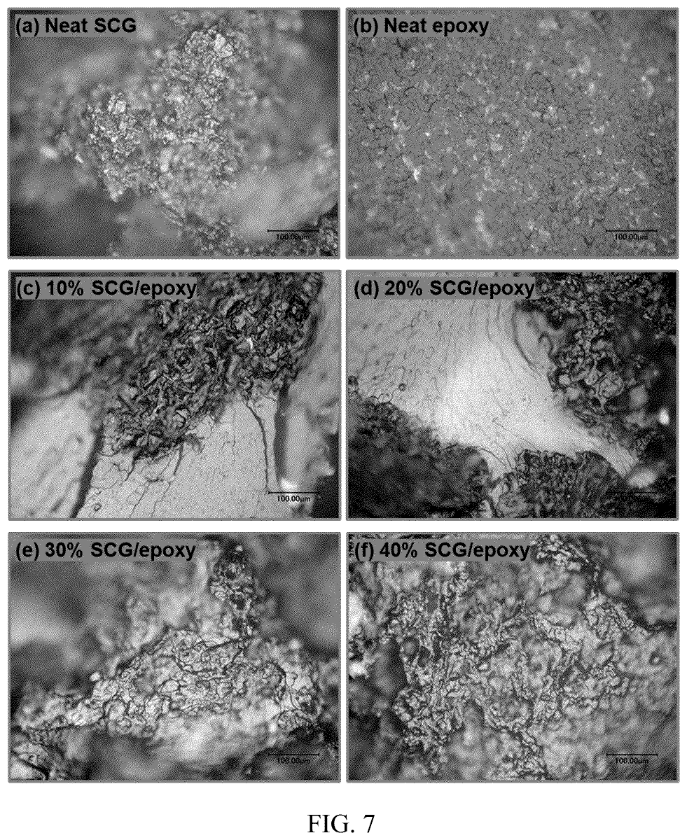

The dispersion and wetting of fillers in a matrix are critical factors to achieve sufficient mechanical properties of composites along with the degree of interfacial adhesion between two phases (Y. Leow et al., RSC Adv 2021, 11 (5), 2682-2692. DOI: 10.1039/dOra09379c). Thus, the surface of neat SCG, fractured neat epoxy, and fractured SCG/epoxy composites were investigated using optical microscopy. The micrographs are shown in FIG. 7, panels (a)-(f). The fractured neat epoxy and SCG/epoxy composites were obtained from tensile testing.

While the neat SCG particles in FIG. 7(a) show coarse surface texture with numerous pores, SCG particles in SCG/epoxy composites in FIGS. 7(c-f) have a relatively smoother surface coated with epoxy matrix. The high degree of wetting by the epoxy matrix is presumably due to high interfacial interaction between two phases through transesterification. Moreover, the neat epoxy in FIG. 7(b) shows the microphase separation, composed of BADGE and PEGDGE, due to the different polarities. Continuous microcracks were developed mostly over the dominant BADGE phase, which implies that the flexible PEGDGE phase is likely to play a role in hindering the crack propagations.

When the weight fraction of SCG is lower than 20% w/w, two distinct phases of epoxy matrix and SCG fillers are observed in FIG. 7 Error! Reference source not found.(c and d). Since the mechanical properties of the SCG/epoxy composite can be determined by the combination of two phases, the continuous epoxy phase, which has a high tensile strength of ˜60 MPa, is expected to support the extensional load greater than the SCG phase. In contrast, when the weight fraction of SCG is higher than 20% w/w in FIGS. 7(e and f), the fracture is observed mostly in the vicinity of SCG particles without the notable continuous epoxy phase. The mechanical properties of SCG/epoxy composite in FIG. 6 support the observations that the tensile strengths abruptly drop with the addition of SCG due to the loss of continuous epoxy phase, and gradually level off beyond 20% w/w of SCG where the support of epoxy phase is negligible.

### Rheology of SCG/epoxy Composites

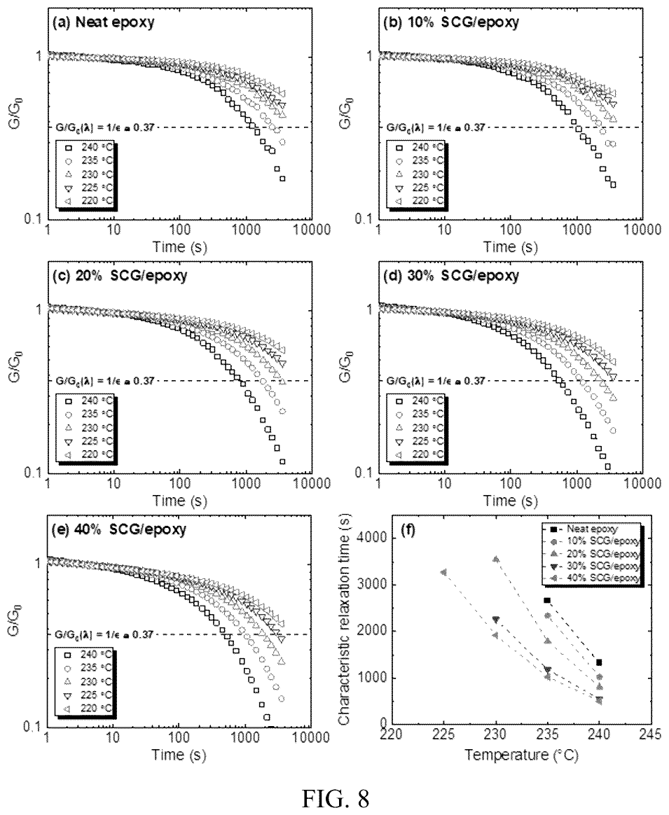

Vitrimers can relax the applied stress through dynamic chain exchange reaction at high temperatures even with the crosslinked network (M. Capelot, et al., ACS Macro Letters 2012, 1 (7), 789-792. DOI: 10.1021/mz300239f). FIG. 8 (panels a-f) shows the dynamic chain exchange kinetics monitored from stress relaxation for neat epoxy and SCG/epoxy composites with various SCG contents up to 40% w/w.

All epoxy and SCG/epoxy composites show stress relaxations with time through transesterification. Interestingly, the stress relaxation of neat epoxy was observed even though the epoxide/cyclic anhydride reaction was expected not to generate hydroxyl groups. It is presumably because a small amount of hydroxyl groups can be generated by the termination of anionic intermediates with water molecules in the catalyst of Zn(acac)₂ (G. P. Kar et al., Ibid.). Following the reported method of M. Capelot et al. (Ibid.), the characteristic relaxation time (2) can be determined from the normalized shear modulus under the assumption that the stress relaxation follows the Maxwell relaxation model:

$$G ( t ) = {G}_{0} exp ( - t / λ ) \qquad ( 1 )$$

where G(t) is the shear modulus at the time t and G₀ is the initial shear modulus. Accordingly, the characteristic relaxation time can be defined when the normalized shear modulus reaches G(λ)/G₀=exp (−1)≅0.37 at t=λ. FIG. 8(f) shows that the relaxation rate increases as the weight fraction of SCG increases at the same temperature. Since the number density of hydroxyl groups in the epoxy matrix and fatty acid remaining in SCG (˜2% in SCG) would be small, the acceleration of relaxation rate with the increase of SCG content implies that the hydroxyl group on the surface of SCG particles clearly participate in the transesterification.

The relaxation rate was accelerated as the temperature increases. Since the stress relaxation by transesterification depends on the thermo-dynamic chain exchange reactions over the crosslinked network, the temperature-dependent relaxation rate, which is often assumed to be the reciprocal relaxation time, can be described using the Arrhenius equation:

$$relaxation rate = 1 / λ = C exp ( \frac{- {E}_{a}^{*}}{R T} ) \qquad ( 2 )$$

where C is the temperature-independent constant, Eₐ* is the critical activation energy barrier for dynamic chain exchange reaction, R is the ideal gas constant, and T is temperature. Eq. 2 can be rearranged into:

$$ln ( λ ) = ( {E}_{a}^{*} / R ) ( 1 / T ) + ln ( 1 / C ) \qquad ( 3 )$$

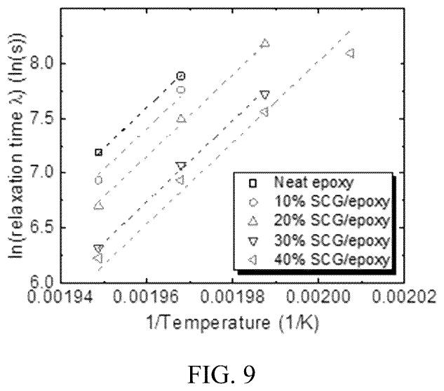

The slope and y-intercept of the Arrhenius plot in FIG. 9 yield Eₐ*/R and In(1/C), respectively. For all weight fractions of SCG, nearly identical activation energies are observed to be Eₐ*≅300 kj/mol, while the temperature-independent constant C increases with the weight fraction of SCG. Since the type and concentration of catalyst are constant for all SCG/epoxy composites, the nearly identical activation energies imply that the energy required for transesterification with a set of ester and hydroxyl groups is independent on the SCG content. On the other hand, the temperature-independent constant would be affected by the number density of the reactive species. Thus, a higher fraction of hydroxyl groups supplied by SCG would increase the temperature-independent constant C.

Glass and Topological Freezing Transition Temperatures of SCG/epoxy Composites

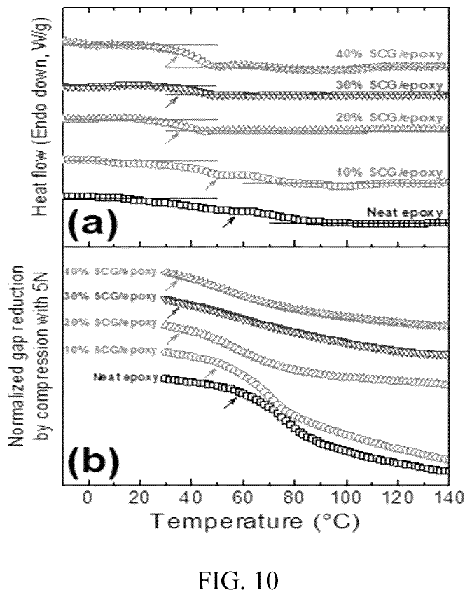

The glass transition temperature (T_{g}) of polymeric material is generally regarded as the reversible transition point from a brittle glassy state into a rubbery state in amorphous phase as the temperature increases. Typically, the heat capacity and modulus significantly changes near T_{g}. FIG. 10 (panels a and b) shows the T_{g} of neat epoxy and SCG/epoxy composites with various SCG contents up to 40% w/w, investigated using DSC and compression on heating.

In FIG. 10(a), no exothermic peak was observed on the first heating up to 140° C., confirming the complete curing at 150° C. for an hour. The T_{g} of neat epoxy and SCG/epoxy composites were determined at the middle point of the heat flow transition as indicated by arrows. Compared to neat epoxy, the addition of SCG filler lowered T_{g} and saturated around ˜30° C. beyond the SCG content of 20% w/w. Since the T_{g} of lignocellulose, which takes the largest fraction of SCG, was reported to be 19 to 33° C.(M. V. Ramiah et al., Journal of Polymer Science Part C: Polymer Symposia 1965, 11 (1), 27-48. DOI: 10.1002/polc.5070110105), the shift of T_{g} to lower temperatures is presumably attributed by SCG fillers. Heat flow transition along with thermal softening can be used to detect T_{g} due to the glass-rubber transition. FIG. 10(b) shows that the onset of abrupt gap reduction by the constant-force-compression on heating agrees with the T_{g} defined by DSC.

Along with a traditional glass transition temperature (T_{g}), vitrimers have an additional characteristic transition temperature known as a topological freezing transition temperature (Tᵥ). Below Tᵥ, the dynamic chain exchange reactions become slow exponentially and the crosslinked networks act like a classical thermoset material, while the vitrimer can flow beyond T_{g} (M. Chen et al., ACS Macro Lett 2019, 8 (3), 255-260. DOI: 10.1021/acsmacrolett.9b00015). Traditionally, the Tᵥ for a vitrimer has been determined at which the zero-shear viscosity reaches η₀ (Tᵥ)=10¹² Pas (M. Capelot, Ibid.). From the simple shear modulus/viscosity relation, the characteristic relaxation time at Tᵥ can be calculated by the following equation:

$$λ ( {T}_{v} ) = {η}_{0} ( {T}_{v} ) / G ( {T}_{v} ) \qquad ( 4 )$$

where η₀ (Tᵥ) and G(Tᵥ) are the zero-shear viscosity and shear modulus at Tᵥ. Since G(Tᵥ) is generally assumed to be ˜1 MPa at Tᵥ, the characteristic relaxation time at T_{g} yields λ(Tᵥ)=(10¹² Pas)/10⁶ Pa=10⁶ s. Hence, the T_{g} of neat epoxy, SCG/epoxy composites with the SCG content of 10, 20, 30, and 40% w/w were determined to be 196, 195, 194, 191, and 190° C., by extrapolating the fitted linear line in FIG. 9 to λ(Tᵥ)=10⁶ s. When the weight fraction of SCG increases, T_{g} shifts to lower temperatures.

Malleability of SCG/epoxy Composites

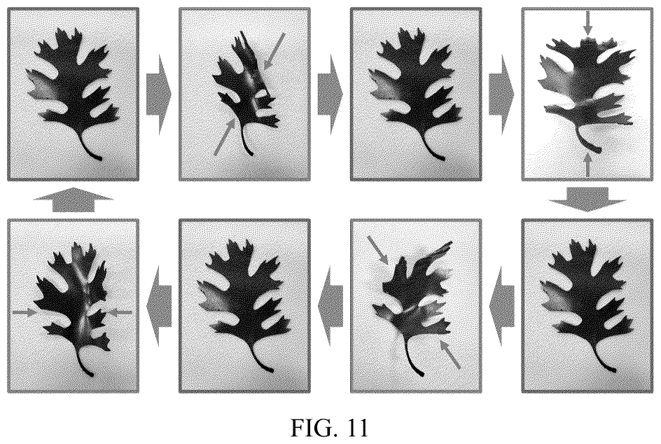

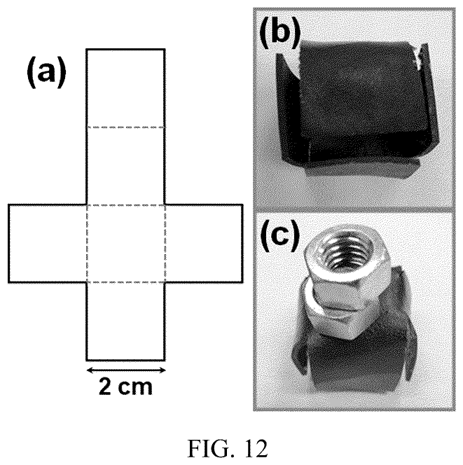

Dynamic chain exchange reaction, like transesterification, can rearrange the crosslinked network structure at elevated temperatures, allowing re-shaping or re-processing (L. Yu et al., ACS Applied Polymer Materials, 2019, 1(9), 2535-2542). To demonstrate the malleability of SCG/epoxy composites, shape manipulation and simple origami were performed using a 30% SCG/epoxy composite as shown in FIGS. 11 and 12. The dynamic chain exchange reaction of a vitrimer is an associative reaction in which the original crosslinked network is broken only when a new bond is formed. Thus, the crosslinking density of a vitrimer is preserved even at high temperatures without losing the dimensional stability. FIG. 11 demonstrates that the oak leaf did not lose the shape in recurring heat/cool/heat cycles. Moreover, shape manipulation conducted at 150° C. confirms that the re-shaping of SCG/epoxy composite was feasible in diverse directions, which indicates the potential application for thermoforming. All deformed samples were recovered back to a flat sheet within 3 minutes at 150° ° C. In addition, a three-dimensional cube structure was demonstrated by folding a planar design. The self-standing cube structure was robust, supporting two nuts (˜20 g) on the top as shown in FIG. 12.

### Conclusions

In this study, spent coffee ground (SCG) was employed as a natural filler in a polyester-based epoxy matrix. A series of SCG/epoxy composites were evaluated with various SCG contents of 10, 20, 30, and 40% w/w in terms of chemical, mechanical, thermal, and rheological properties. Although the polyester-based epoxy matrix has a crosslinked network, re-shaping of SCG/epoxy composite was successfully demonstrated at elevated temperatures through transesterification. The dynamic chain exchange reaction between the ester group of epoxy matrix and the hydroxyl group of SCG fillers was confirmed from the acceleration of relaxation rate with the increase of SCG contents in the SCG/epoxy composite. The transesterification enhanced the interfacial adhesion between epoxy matrix and SCG fillers as well, resulting in practically sufficient tensile strength (>20 MPa) and modulus (˜2.5 GPa) even with a high weight fraction of SCG up to 40% w/w.

### Example II—Cellulose Fiber-Reinforced Rigid Polyester-Based Epoxy Vitrimer

A malleable fiber-reinforced epoxy-based vitrimeric composite was prepared by utilizing randomly oriented cellulosic fiber mat as a reinforcement and anhydride-cured epoxy resin as the matrix. Inherently, anhydride-cured epoxy matrix, when processed in moisture-free conditions, results in only the formation of ester-based networks. Even though the ester based crosslinked system has a potential capability for thermally driven dynamic bonding, such as transesterification, the dynamic chain exchange is challenging due to the lack of neighboring hydroxyl moiety. In this study, the hydroxyl group functionalities were employed from the external fibrous reinforcement into the ester-based matrix so that not only topological rearrangement or dynamic bond exchange of the crosslinked system was successfully demonstrated at elevated temperatures, but excellent mechanical properties were also obtained.

### Materials:

Whatman qualitative filter paper with a slow-medium flow rate (with a medium filtering speed, basis speed of 75 g/m2) and a diameter of 185 mm was commercially obtained and used as received. Bisphenol A diglycidyl ether (DGEBDA), methyl nadic anhydride (MNA), Zinc acetylacetonate hydrate (Zn(acac)₂), and acetone (ACS grade 99%), were commercially obtained and used as received without further purification.

Fabrication of epoxy vitrimer/reinforced vitrimer composite:

First, a polyester-based vitrimer matrix was synthesized by undergoing a chemical reaction between the epoxy functional groups on BADGE and cyclic anhydride functionalities on MNA, in the presence of Zn(acac)₂ vitrimer catalyst. The polyester based vitrimer matrix was prepared by varying the stoichiometric feed ratio of epoxide and cyclic anhydride functional groups, Vitx:y (x:y=[epoxy]:[cyclic anhydride]=0.75:1, 1:1, 1.25:1, 1.5:1). The experimental protocol to synthesi polyester-based vitrimer matrix is described in Example I and in Seo et al. “Polyester-based epoxy vitrimer integrating spent coffee ground as a natural filler,” Composites Part B: Engineering, p. 110756, 2023. Briefly, BADGE and Zn(acac)₂ (5 mol % relative to epoxy groups) were taken in a dried glass vial and heated at 150° C. for 10 minutes to afford a homogenous solution. This BADGE/Zn(acac)₂ was further mixed with MNA at room temperature in a SpeedMixer (FlackTek, SC) at 2500 rpm for 10 minutes resulting in a homogenously mixed milky-white epoxy solution. The epoxy solution was then transferred to a custom-made polytetrafluoroethylene (PTFE) mold, degassed under vacuum and cured at 150° C. for 1 hour in an oven.

To fabricate the vitrimer composite, the epoxy and anhydride-based monomer precursors i.e., BADGE and MNA respectively, along with vitrimer catalyst Zn(acac)₂ were premixed using the aforementioned procedure. 60 ml of acetone was added as a diluent in the monomer precursor solution. The solution was stirred using a magnetic bead to ensure complete homogeneity of the reaction mixture. The Whatman qualitative filter paper and rayon/polyester-based gauze were used as a fibrous, interwoven reinforcing scaffold for the vitrimer composite. The fibrous scaffold was impregnated with the reaction mixture by dipping it in the diluted BADGE/MNA/Zn(acac)₂ solution for 10 minutes to ensure saturation of the scaffold with the monomer precursors. Both filter paper and rayon/polyester-based gauze showed instant absorption of the solution, thereby ensuring adequate dispersion of reactive moieties. The solution dipped fibrous scaffold was then transferred to a convection oven and heated at 60° C. for 12 hours to completely evaporate acetone diluent, followed by curing it at 150° C. for 1 hour under pressure using a Carver hydraulic laboratory press.

### Fourier-Transform Infrared Spectroscopy (FTIR) Analysis

The FTIR spectra was recorded for all the neat epoxy vitrimers, vitrimer composite systems and pre-polymerized monomers to characterize the functional groups and analyze the chemical structure. The FTIR spectra and measurements were collected in attenuated total reflection (ATR) mode as averages of 32 scans in the transmittance range of 4000 to 600 cm⁻¹ on a Frontier FT-IR/NIR Spectrometer (PerkinElmer, SC). All the spectra were recorded at room temperature.

### Thermal Analysis:

The Differential Scanning calorimetry (DSC) analysis was performed to determine the glass transition temperature (T_{g}) of all the neat epoxy vitrimers and vitrimer composite systems. The DSC analysis was performed using a heat/cool/heat thermal cycle on a Q2000 (TA Instruments, New Castle, DE), between −70 to 200° ° C. with a heating and cooling rate of 10° ° C./minute. For each run, ˜10 mg of sample was added to a T-Zero aluminum pan. The thermal stability and degradation of all the monomer precursors, neat epoxy vitrimers and vitrimer composite systems were characterized on a Q500 (TA Instruments, New Castle, DE) under nitrogen purge. Each sample was heated from 25° ° C. to 800° C. at a heating rate of 10° C./minute and corresponding change in weight percent was recorded as a function of time.

### Mechanical Testing:

Uniaxial tensile tests were performed to analyze the mechanical properties of all the neat epoxy vitrimers and vitrimer composite systems by using a MTS Criterion model 42 with dog-bone specimens, following ASTM-D638. The gauge and thickness dimension were measured for each specimen prior to testing and a minimum of four samples were tested for each sample. The tensile measurements were performed using a 5000 N load cell at a strain rate of 5 mm/min. Young's modulus was calculated from the slope of stress-strain curve between the strain value of 0.1% and 0.2% for each sample.

### Rheology:

Rheological measurements were performed to investigate the dynamic properties of the neat epoxy vitrimer and vitrimer composites using a DHR-3 rotational rheometer (TA Instruments, New Castle, DE). For each experiment, the rheometer was equipped with a 8 mm stainless steel parallel plate and a Peltier plate. In stress relaxation experiments, the shear modulus was monitored with time (approx. 1 hour) on application of a shear strain of 0.01% at temperatures of 220 to 250° C. Before each stress relaxation measurement, the sample was equilibrated for 5-minutes at the experimental temperature.

### Malleability:

The vitrimer composite samples were cut into rectangular strips of length 7 cm and width 3 cm. The composite sheet was first softened in a convection oven at 150° C. for 15 minutes. After preheating the composite, the shape was manipulated using tweezers, and the sample was allowed to cool to room temperature to lock it into a new shape. All images of the samples were taken at room temperature.

### Recyclability:

A small 0.5 g section of neat vitrimer 1:1 was immersed in 25 g of ethylene glycol. The solution was transferred to a round bottom flask and refluxed at 180° C. for 48 hours. The vitrimeric matrix was completely dissolved after 48 hours and a dark-brown colored ethylene glycol solution was recovered.

### Results and Discussion

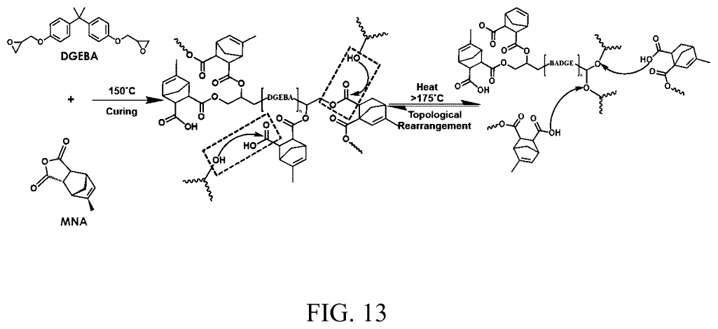

A cellulose reinforced vitrimer composite was fabricated by employing a polyester-based resin as the vitrimeric matrix and utilizing a natural cellulose paper as a reinforcing scaffold. Herein, a polyester-based vitrimeric resin was synthesized by using a classical anionic ring opening copolymerization between an epoxy and cyclic anhydride containing monomer precursors in the presence of Zn(acac)₂, a transesterification catalyst. The crosslinking reaction, initiated by hydrated Zn(acac)₂, leads to the formation of alkoxide intermediates from the epoxide groups of DGEBDA. These intermediates further react with cyclic anhydride groups of MNA yield carboxylate ions, which can further propagate the formation of ester moieties of reaction with epoxide groups to yield a polyester-based crosslinked network. Additionally, nucleophilic attack of carboxylate ions on the epoxy groups yields to formation of β-hydroxy groups alongside ester moieties which are instrumental in activating transesterification exchange reactions (TERs) at elevated temperature in the presence of Zinc (II) catalyst. These thermally stimulated TERs result in the topological rearrangement of the overall matrix resulting in changes in the viscoelastic properties of the vitrimer, thus assisting in imparting various sought-after properties like self-healing, malleability and recyclability to the vitrimer composite. FIG. 13 illustrates a simple case of reaction between epoxy containing DGEBDA and cyclic anhydride containing MNA, leading to the formation of an ester-based covalently adaptive network. This network undergoes topological rearrangement or dynamic bond exchange through transesterification, facilitated by other functionalities like β-hydroxy groups and unreacted carboxylate groups.

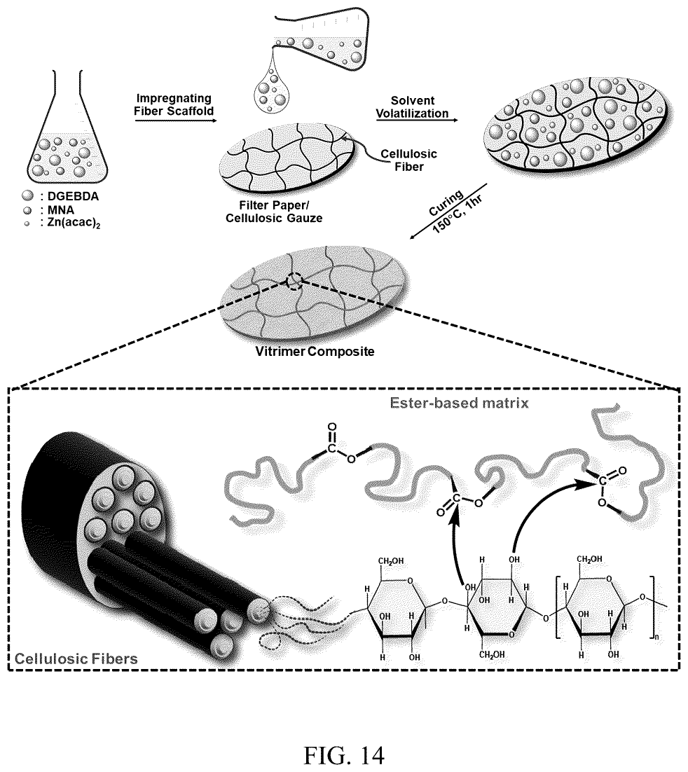

A series of neat vitrimer and cellulose reinforced vitrimer composite samples were fabricated by varying the stoichiometric feed ratio of epoxy groups in DGEBA and cyclic anhydride groups in MNA. For neat vitrimer and vitrimer composites, the [epoxy]:[cyclic anhydride] ratio was varied from 0.75:1 to 1.5:1. Due to the requirement of high temperature (150° C.) for the curing reaction between epoxy and cyclic anhydride containing monomers, the monomer precursors were initially mixed thoroughly using acetone as a diluent. Subsequently, the mixture was poured onto the fibrous scaffold. As the cellulose paper possesses a porous structure, it exhibited excellent absorbency, allowing the monomer solution to disperse well and impregnate the fibrous scaffold. Although the impregnation method was already very facile, resin transfer within the cellulose scaffold can be further accelerated by vacuum assisted resin transfer method. After complete removal/evaporation of the acetone diluent, the resin impregnated cellulose paper was cured at 150° C. for 1 hour to complete the in-situ polymerization of the monomers inside the fibrous scaffold, resulting in the fabrication of vitrimer composites (VC). On a few occasions, in this disclosure, vitrimer composite (VC) has also been termed as vitrimer-paper composite (VP). The weight percentages of vitrimer inside the composite are 21.5, 22.5, 20.5, 23.8 for samples VC0.75:1, VC1:1, VC1.25:1, and VC1.5:1, respectively. FIG. 14 outlines the fabrication procedure used for vitrimer composite. The figure also illustrates the functionalities (hydroxyl groups) on cellulose fibers that participates in the chemical exchange with ester-based matrix.

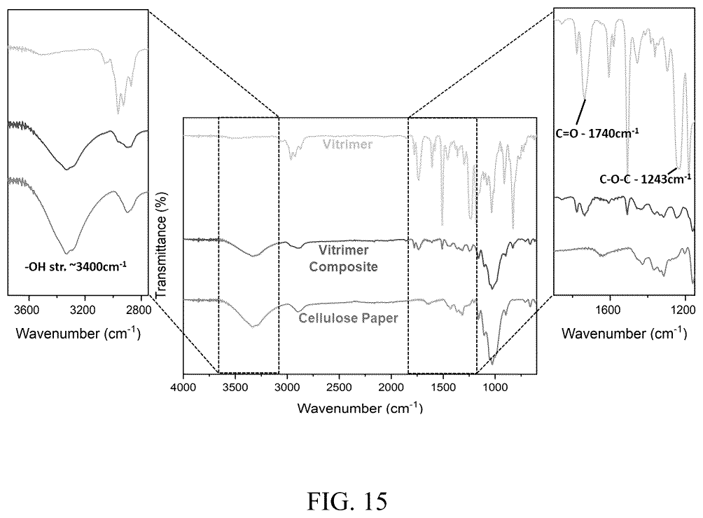

The FTIR analysis assisted in characterizing the crosslinking reaction between the epoxides and cyclic anhydride species in both neat vitrimer and VC systems. The chemical reaction between these two functional groups led to the formation of ester linkages, which can be identified by emergence of two characteristic ester peaks. These peaks were observed at 1740 cm⁻¹, attributed to the carbonyl C═O stretching, and C—O—C ether stretching at 1243 cm⁻¹. These peaks can distinguishably be observed in both neat vitrimer and VC spectra (FIG. 15). In the FTIR spectra for blank cellulose paper, a significantly broad —OH stretching peak is observed at ˜3400 cm⁻¹. In the case of the neat vitrimer samples, the —OH stretching peak has much weaker intensity of —OH stretching vibrations because of much lower concentration of β-hydroxy groups in the ester-based matrix. However, with incorporation of vitrimer inside cellulose matrix, there is a significant increase in the intensity of —OH stretching vibrations, alongside exhibiting characteristic ester peaks at 1740 cm⁻¹. The presence of B-hydroxy groups and alcohol functionalities of cellulose fiber are instrumental in undergoing TERs with ester linkages at elevated temperatures, thereby imparting sought after properties like malleability, recyclability, and shape memory to the VC.

### Thermal Stability and Glass Transition Temperature:

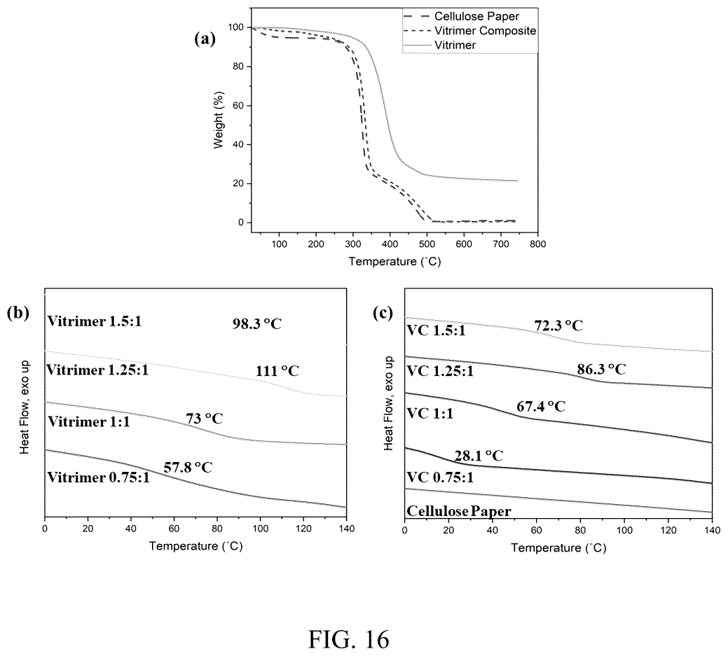

The thermal stability of the neat filter paper, vitrimer and VC composite was evaluated by performing thermogravimetric analysis (TGA) experiments as shown in FIG. 16(a). The results indicated that the incorporation of vitrimer matrix significantly improved the thermal stability of the cellulose paper. The neat cellulose paper demonstrated a 5% weight loss temperature (T_{d}5%) of 95.7° C., which was significantly increased to the range of 205 to 232° ° C. for different VC samples. In the case of neat-vitrimers, the T_{d}5% was roughly in the range of 295° C. (Vit1:1) to 310° C. (Vit1.5:1). Notably, each VC composite impregnated roughly 15-25 weight % of vitrimer as matrix.

In FIGS. 16(b) and 16(c), the DSC thermograms revealed an increase in the glass transition temperature (T_{g}) for both neat vitrimer and VC samples when the stoichiometric feed ratio of DGEBDA was increased. This increase can be attributed to the inclusion of a bulkier and aromatic building block in the vitrimeric matrix. The T_{g} increased from 57.8° C. for Vit0.75:1 to 111° C. for Vit1.25:1. Similar trend was also observed in VC samples as the T_{g} increased from 28.1° ° C. for VC0.75:1 to 86.3° C. for VC1.25:1, whereas for neat cellulose paper reinforcement, the T_{g} was not detectable. These results are interrelated with the fact that both crosslinking density and rigidity of the samples increased remarkably with an increase in the amount of aromatic epoxy resin, i.e., DGEBA. However, upon further increase in the amount of epoxy resin, there was a significant dip in the T_{g} of both neat Vit1.5:1 and VC1.5:1. This could be attributed to the fact that a degree of crosslinking between epoxy groups of DGEBA and anhydride groups of MNA occurred at molar concentration of 1.25:1; hence, upon further increase in the content of inherently bulky and aromatic epoxy resin, the crosslinking density could not increase, thereby resulting in some uncured and free-standing epoxy molecules (monomer), thereby dropping the T_{g} for both neat Vit1.5:1 and VC1.5:1. Interestingly, reinforced composites exhibit 10-30° C. lower T_{g} than the neat corresponding resins. The presence of moisture through hygroscopic cellulosic fibers likely plasticizes the neat anhydride-cured epoxy polymer matrix.

### Mechanical Properties of Vitrimer Composite:

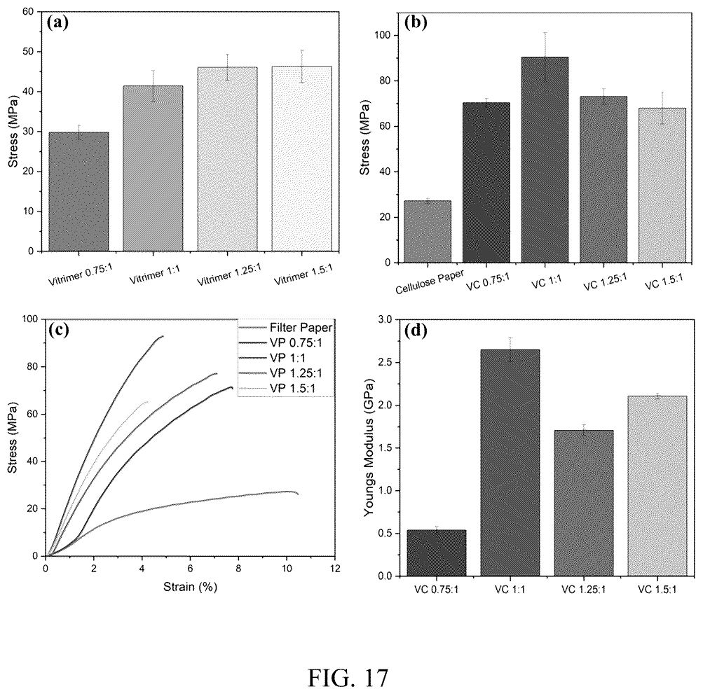

Mechanical properties play a crucial role in defining the final application of a vitrimeric material. Uniaxial tensile testing was used to examine the mechanical properties of all the neat vitrimer and VC composite samples. With the increase in [DGEBA]/[MNA] ratios from 0.75:1 to 1.5:1, there was a significant improvement in the fracture strength of vitrimeric material from 29.8 MPa to 46.3 MPa as shown in FIG. 17a. The gradual increase in the mechanical properties can be attributed to the increased loading of inherently aromatic and hard backbone of DGEBA in the vitrimer network. The increased molar ratio of epoxy groups from DGEBA results in a more densely crosslinked system, thereby improving the fracture strength as well. The randomly oriented interwoven cellulose fibers in a paper experience strong inter-layer hydrogen-bonding interactions and thereby demonstrate high fracture strength of 27.2 MPa. On impregnating the fibrous scaffold with the vitrimeric matrix, the composite experienced a much higher fracture strength than the neat vitrimer and neat cellulose paper, as shown in FIG. 17b. The vitrimer composite exhibited a fracture strength ranging from 65.6 MPa for VC1.5:1 to as high as 90.5 MPa for VC1:1 with mere 15-25 volume % of vitrimer loading. Among all the compositions, the VC1: 1 composite demonstrated the highest average tensile strength of 90.5 MPa. The much higher fracture strength for all the vitrimer composites can be attributed to the appreciable increase in the interfacial adhesion due to ester exchange reaction between the epoxy matrix and the functionalities on the fiber. Moreover, impregnation of the fibers with vitrimer matrix led to appreciable increase in the secondary hydrogen bonding interactions which also assisted in increasing the fracture strength.

### Rheological Properties of Vitrimer Composite:

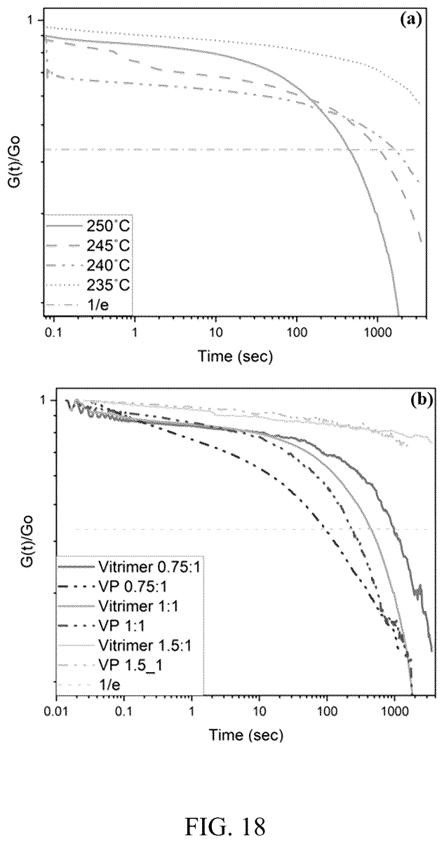

Flow behavior through dynamic chain exchange reaction is one of the characteristic properties of vitrimer; therefore, thermal stress relaxation of neat and cellulose-fiber-reinforced vitrimer were monitored at high temperatures. Herein, a constant shear strain of 0.01% was applied on a sample and the stress response is recorded as a function of time. Typically, the dynamic character of a covalently adaptive network is governed by various factors like spatial orientation of bonds, macromolecular architecture and molarity of reactive groups [Taplan et al, “Fast processing of highly crosslinked, low-viscosity vitrimers,” Materials Horizons, vol. 7, no. 1, pp. 104-110, 2020]. These factors collectively contribute to guide the exchange kinetics and rate of relaxation. In the case of vitrimer and vitrimer composites, it has been observed that the increase in the temperature results in a greater number of productive exchanges between the reaction partners, thus accelerating the exchange rate. FIG. 18a shows exponential increase in the relaxation rate of the VC_{1:1} with increasing the experiment temperatures from 235° C. to 250° C. Similar relaxation trends were also observed for other vitrimers and VC composite samples. As the cellulosic fibrous scaffold consists of abundance of hydroxyl (OH) groups, the presence of residual hydroxyl groups promotes an even faster relaxation as compared to a neat vitrimer, as shown in FIG. 18b. As evidenced by the stress relaxation experiments at a fixed temperature of 250° C., the neat vitrimer 1:1 demonstrated a relaxation time of 1660 s whereas the VC_{1:1} had a relaxation time of mere 245 s. This faster relaxation for VC_{1:1} can be attributed to the abundance of hydroxyl groups from cellulosic reinforcement which interacted with neighboring ester linkages present in the matrix to yield transesterification exchange reactions, thereby increasing the rate and tendency to undergo productive exchange as compared to the neat vitrimer. It is noted that stress relaxation of neat vitrimers was still observed even without the support of hydroxyl groups from cellulose fibers, presumably due to a small amount of hydroxyl groups that can be generated by water molecules in hydrated Zn(acac)2.

With the increase in the molar ratio of epoxy group in the reaction matrix, a significantly slower relaxation was observed. For example, vitrimer 1:1 demonstrated a relaxation time of 1600 s at 250° C. whereas vitrimer 1.5:1 was not able to stress relax during the course of experimental setup i.e. 3600 s. This could be attributed to the abundance of epoxy group present in the matrix which might hinder the nucleophilic attack of hydroxyl group with the nearby ester moiety. Similar observation was also made for VC_{1.5:1} composite, where even with the presence of abundance of hydroxyl groups, the relaxation rate was significantly slower than VC_{0.75:1} and VC_{1:1}.

Phase Behavior and Dynamics by ¹H Time Domain Nuclear Magnetic Resonance (NMR) spectroscopy:

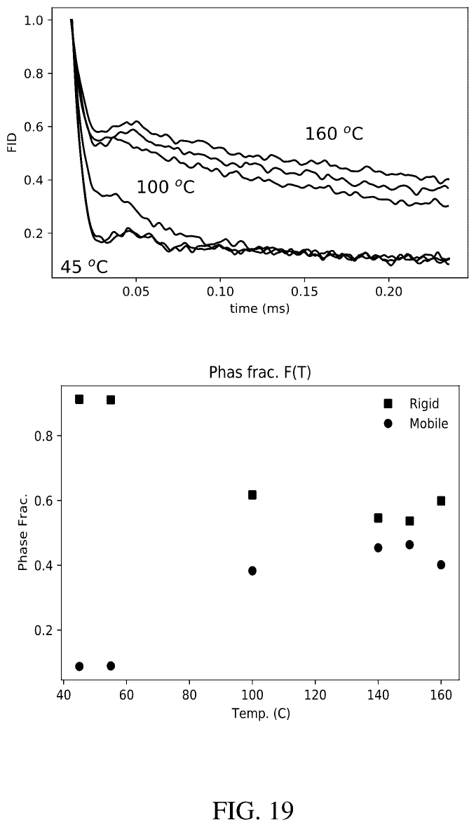

The cellulose hydroxyl group enabled contrasting phase dynamics of a typical cellulose fiber-reinforced composite (VC 1:1) and neat vitrimer (vitrimer 1:1) at elevated temperatures was investigated by low-field NMR spectroscopy. ¹H time domain NMR was collected on the neat vitrimer and paper reinforced vitrimer composite sample on a Minispec MQ20 Bruker Corp system operating at 20 MHz ¹H frequency, see FIG. 19. The free induction decays were collected using a single 90° excitation pulse of 3 us and an instrument dead time of ˜ 9 μs. Variable temperature was measured over a wide range from ambient to 200° ° C., depending on the sample using a BVT3000. 1H signals were fit following the method outlined in V. Rantzsch et al. “Polymer crystallinity and crystallization kinetics via benchtop ¹H NMR relaxometry: Revisited method, data analysis, and experiments on common polymers” Polymer 145 (2018) 162-173.

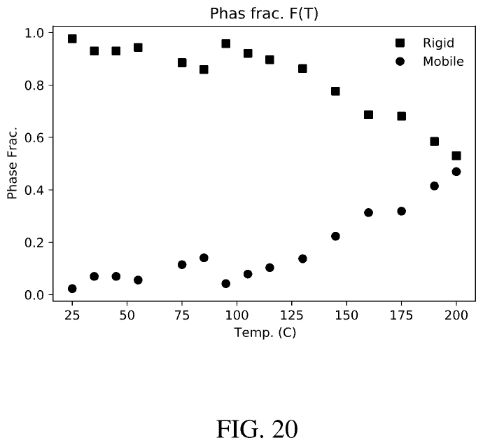

A three-component fit was applied using the equation below:

$$FID = {A}_{a} \times exp ( {( t / T {2}_{a} )}^{2} ) sin ( bt ) / ( bt ) + {A}_{g} \times exp ( {( t / T {2}_{g} )}^{2} ) + {A}_{m} \times exp ( {( t / T {2}_{m} )}^{c} )$$

where Aₐ represents the crystalline component, A_{g} the amorphous rigid and Aₘ the mobile component. The crystalline and amorphous rigid components are combined into a single term ‘rigid’ shown in the plot (FIGS. 19 and 20). It is important to emphasize that this technique only ‘counts’ protons, so making mass conversion calculations is only possible with homogeneous structures or if the molecular weights of the molecules used are precisely known for each phase. It does nevertheless quantitatively reflect all protons, their phase and dynamics in the system. As can be seen in FIG. 19 (top panel), a strong crystalline signal appears from the fast-decaying signal which has a characteristic oscillatory dip at ˜25 μs, see Rantzsch et. al. With increasing temperature, the long tail becomes a larger fraction of the total fid reflecting faster dynamic polymer rearrangements enabled by the vitrimer chemistry. At 100° C. the mobile fraction has increased substantially and stabilizes around 150° C. to ˜ 55:45 split of rigid to mobile phase (FIG. 19, bottom panel). At this elevated temperature, one can still see the crystalline fraction from the cellulose, which suggests that the mobility is primarily from the vitrimer components. Compared to the pure vitrimer components (FIG. 20) the cellulose containing system has an earlier onset of dynamic exchange. In the pure vitrimer, the phase components remain fairly constant up to 125° C. after which the phase components begin to change. As such, it would appear that the cellulose hydroxyl groups are enabling vitrimer exchange at earlier temperatures than the pure vitrimer. These results demonstrate a unique effect of this composition exhibiting reinforcement by the hydroxyl group containing rigid fibers while inducing malleability that is difficult to achieve in neat polymer resin.

### Multifunctional and Additive Manufacturing Properties of Vitrimer Composite:

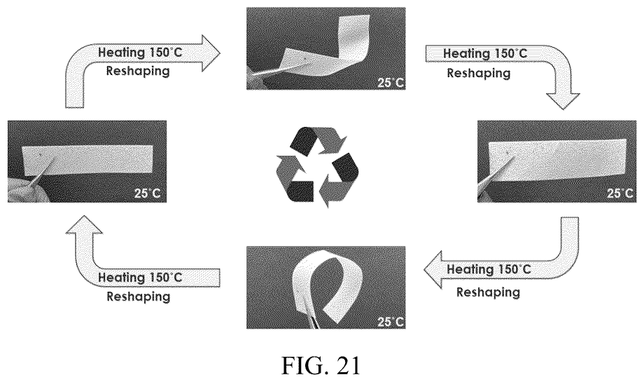

Crosslinked polymer matrices that possess dynamic covalent linkages are capable of undergoing rearrangement of the networked structure through chemical exchange reactions such as transesterification. This rearrangement, triggered by thermal stimulation, endows the material with the properties of reshapability, reprocessability, and malleability. To demonstrate potential recycling of composite specimens by exploiting their thermal malleability, repeated reshaping and remolding (by compression) of a composite laminate was conducted as demonstrated in FIG. 21.

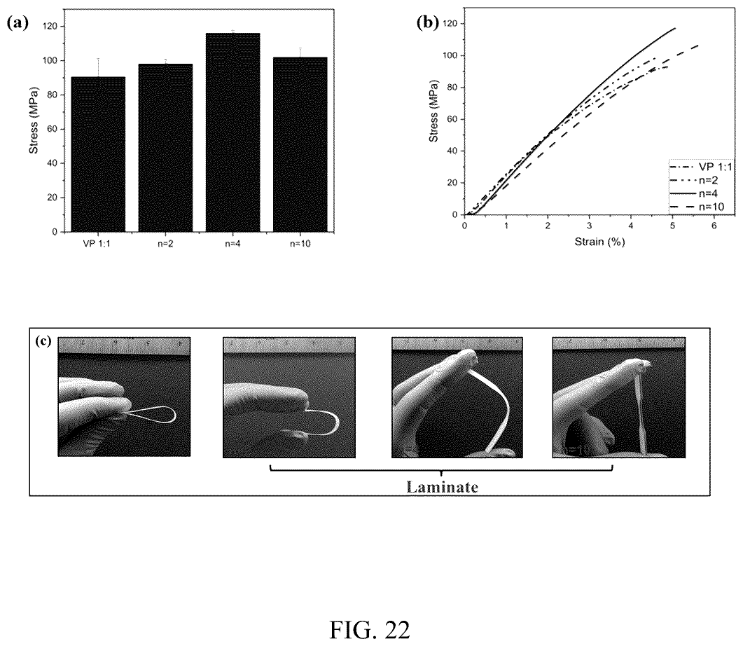

Additionally, the additive manufacturing potential of the vitrimer composite tape was investigated by preparing laminate samples via layer-by-layer stacking of vitrimer composite sheets. At first, 2, 4 and 10 VC1: 1 composite layers were stacked and pressed together at 150° C. for 1 hour. The 2n, 4n and 10n VC 1:1 laminate specimen demonstrated an improved fracture strength of 98.1 MPa, 116 MPa and 102.9 MPa respectively (FIG. 22). The improvement in the mechanical properties of the laminate sample can be attributed to the fact that the epoxy-based vitrimer matrix undergoes crosslinking at the interface with the hydroxyl functionalities present on the cellulosic fibers. This exchange reaction enables enhanced fiber-matrix bonding with thermal compression. This formation of new chemical bonds at the interface of the surfaces has a stitching effect between the surfaces that assist in improving the mechanical strength of the laminates. This approach presents a pathway to fabricate a high-strength cost-effective, easy-to-fabricate, damage healable or repairable, load bearing laminate.

### Recyclability of Vitrimer:

The ester-based crosslinked vitrimer synthesized in this study offers complete recyclability through transesterification exchange chemistry. This is achieved by leveraging the hydroxyl functional groups on ethylene glycol, thereby providing a straightforward pathway for a chemical recycling process of the vitrimer composite. Upon thermal stimulation, the hydroxyl functional groups present on ethylene glycol undergo a chemical exchange reaction via TERs with the ester crosslinkages present in the matrix. The networked structure undergoes dissolution as a result of significant drop in the crosslink density upon interaction with excess of ethylene glycol. This experiment provides a pathway for closed-loop recycling of fiber-reinforced vitrimer composite, wherein the vitrimeric matrix is gradually dissolved, enabling the separation of clean fibers. These clean fibers can further be utilized as fillers and combined with fresh vitrimeric matrix, thus offering an opportunity for their continued utilization.

### Example—Fast Relaxing Sustainable Soft Vitrimer with Enhanced Recyclability

This example demonstrates synthesis of vitrimers utilizing 100% renewable and plant-based building blocks that exhibit transesterification exchange reaction (TER) capability. The vitrimer was synthesized by solvent-free, high-shear reactive mixing of a biomass-derived lignin fraction enriched with carboxyl functionality and an epoxidized polyisoprene from natural rubber. The oxirane functionality in rubber reacts catalytically (zinc acetylacetonate) with carboxyl moieties in lignin to form ester at 180° C. The ester linkages in the networked matrix undergo topological rearrangement or dynamic bond exchange upon heating above 180° C., thus enabling (re)processability similar to thermoplastics. The material exhibits fast stress relaxation (characteristic relaxation time of <10 seconds) above 200° ° C., which indicates the material's potential for use in rapid manufacturing of components and their recycling. This approach provides a pathway for circular and value-added utilization of lignin and subsequent use as matrix for reinforced composites.

Conventional rubber products require sulfur, peroxides, or exotic crosslinking agents to create permanent covalent networks which induced very high viscosity prohibiting its thermal reprocessing potential. Formulating recyclable yet networked rubber compositions containing only renewable feedstocks poses two key challenges: (1) decoupling the use of common crosslinking or vulcanizing agents and (2) tailoring functionalities in the building blocks that enable dynamic covalent bonding at an appropriate thermal condition. Successful manufacturing of these novel fast relaxing elastomer equivalents from renewable building blocks can alleviate issues pertaining to carbon emission and post-use environmental pollution. Vitrimeric products from renewables are sought-after not only for their recyclability and contribution to circular economy but also for their potential to exhibit additional functionalities such as self-healing and shape recovery. Recent reports on multiple vitrimeric systems, designed exclusively from renewable building blocks, include F. I. Altuna, et al., Green Chemistry, 2013, 15, 3360-3366. and S. Dhers, et al, Green Chemistry, 2019, 21, 1596-1601]. The present disclosure focuses on a combination of soft and rigid segments from renewables that meet fast relaxation criteria along with thermal (re)processability.

The present disclosure considered lignin, a natural polyphenol that is abundant, low-cost and readily available from sustainable sources of non-food plant biomass, as a rigid building block. Structurally, isolated lignin in oligomeric form possesses highly branched, aromatic architecture with a variety of naturally occurring functional groups, such as hydroxyl, aldehydes and carboxylic acids, which can be exploited as reactive sites to design materials with dynamic exchange chemistries that proceed via transesterification, transacetylation, transimination, and more (S. Zhang, et al, Green Chemistry, 2018, 20, 2995-3000 and A. Moreno, et al, ACS Applied Materials & Interfaces, 2021, 13, 57952-57961). When formulated with the combination of lignin in a soft matrix, phase-separated morphologies prevail, depending on the miscibility criteria, leading to a broad range of mechanical properties. Moreover, lignin's inherently complex macromolecular architecture together with its high polydispersity contributes to performance variation that limits its use as sustainable a building block for value-added applications. Another dominant factor that limits lignin valorization is its recalcitrance towards chemical modification due to the strong self-assembly potential through physical interactions between its polar functional groups. In recent years, numerous innovative techniques, such as ozonolysis and catalytic conversion, have been employed to improve reactivity and to tailor its physio-chemical properties. However, most of these procedures are very energy intensive, requiring multi-step synthesis routes that are difficult to control, specifically for technical lignin extracted from black liquors produced during wood pulping. Recently, it was demonstrated that a fraction of Kraft softwood lignin, obtained via solvent extraction, consists of functionally enriched lignin oligomer with improved reactivity and narrower polydispersity lignin (M Cui et al. ACS Macro Letters, 2018, 7, 1328-1332). It was presumed that a highly polar solvent would enhance compatibility and the integration of the solvent fractionated lignin phase within a polar rubber matrix. To test this, acetonitrile was utilized, and importantly, acetonitrile can also be manufactured from renewables (Green chemistry, 2013, 15, 928-933, for fractionation of the Kraft lignin.

It is known that the degree of substitution (DS) in lignin aromatic ring for phenolic, alcohol and aldehyde groups can be almost identical in acetonitrile extracted (ACN-Lignin) and as-received lignin. However, there is almost a five-fold increase in the DS of carboxylic acid groups on extracted ACN-Lignin as compared to the as-received lignin. Secondly, the DS of methoxy groups was reduced by half in the extracted lignin as compared to as-received lignin. These factors synergistically contributed to making ACN-Lignin highly polar and more reactive than as-received lignin. Furthermore, the ACN-Lignin obtained displayed a clear and distinct T_{g} of 75° C., accompanied by a significantly narrower polydispersity of 1.16. In contrast, the as-received lignin sample exhibited no noticeable T_{g} and a higher polydispersity of 1.83. It is surmised that the isolated lignin, being a heterogeneous mixture of molecules, can be thoroughly mixed with a specific solvent that will selectively separate and fractionate only those molecules that are highly interactive and soluble. It can be hypothesized that this polar lignin fraction could be used as a building block to enable better network forming ability, as well as to enhance dispersion within a polymer matrix during reactive mixing and extrusion of the resulting multiphase polymer. The carboxylic acid groups from lignin are reactive (in presence of a catalyst) with oxirane ring in epoxidized building blocks to yield binary mixtures with lignin.

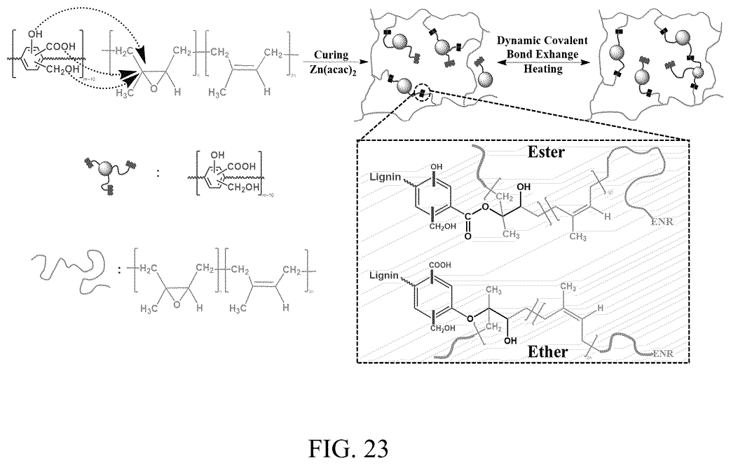

In this work, the reactive carboxylic acid, phenolic and alcohol groups on lignin were exploited for reaction with the epoxy groups of an epoxidized natural rubber containing 25 mol % epoxy content (ENR-25, natural cis polyisoprene that was epoxidized with nearly 25 mol % epoxy). The covalent interactions between the reactive functional groups on lignin and epoxy groups of ENR-25, in presence of zinc(II) catalyst, yield ester and ether linkages (FIG. 23). It is well understood that ester linkages undergo TER in the presence of surrounding —COOH and —OH groups at elevated temperatures, thus making such products behave like vitrimers. As the —COOH group exists as a much stronger acid than corresponding alcohols and phenolic groups due to the presence of resonance stabilized carboxylate ion, the reactivity of —COOH groups with epoxy groups of ENR-25 is herein believed to be higher than that of the alcohols and phenolic groups. Thus, the lignin fraction having higher —COOH content is herein believed be a better building block compared to as-received technical lignin where the average —COOH content is low.

Three vitrimer samples with different ACN-Lignin to ENR-25 ratios were prepared by using a solvent-free high temperature shear-mixing procedure (N Kanbargi et al. ACS Applied Polymer Materials, 2021, 3, 2911-2920) followed by molding in a hot-press at 180° C. for 2 h to ensure complete equilibrium crosslinking. The FTIR spectra confirmed the crosslinking reaction between the reactive functional groups of lignin and epoxy groups of the ENR. The covalent interaction between the epoxy groups of ENR-25 and carboxyl and alcoholic functionalities on lignin lead to formation of β-hydroxy ester and ether linkages which was evidenced by appearance of additional peaks in the vibration band of carbonyl bonds at 1720 cm⁻¹ and aromatic ether bonds at 1250 cm⁻¹ upon curing. The higher content of lignin in the reaction matrix leads to higher concentration of formed ester linkage (1720 cm⁻¹) along with an increased concentration of β-hydroxy groups at 3400 cm⁻¹. The presence of β-hydroxy groups along with the unreacted alcoholic moieties are instrumental in undergoing TERs with ester linkages at elevated temperature. The increased loading of ACN-Lignin enabled formation of material with higher crosslink density due to more reactive functional groups being engaged with epoxy groups of the ENR-25. This was evidenced by a systematic increase in the gel content on increasing the weight fraction of ACN-Lignin in the overall matrix (see Table 1). The decrease in swelling ratio and increase in gel content is often correlated to the increase in the crosslink density of the material. Both ACN-Lignin and ENR-25 can dissolve well in THF, thus it was used as a solvent for gel content and swelling experiments.

TABLE 1
Composition and properties of TER-based ACN-Lignin/ENR vitrimer

| | ACN- | | | | Gel | | | | Tensile | Elongation |
|---|---|---|---|---|---|---|---|---|---|---|
| | Lignin^{a} | T_{g}^{b} | T_{d5%}^{c} | Tₛ^{d} | Content ^{e} | Eₐ^{f} | t*_{210° C.}^{g} | Tᵥ^{h} | Strength | at Break |
| Sample | (wt %) | (° C.) | (° C.) | (° C.) | (%) | (kJ/mol) | (s) | (° C.) | (MPa) | (%) |
| ENR25 | 0 | −47 | 328 | 172.0 | 0 | — | — | — | 0.3 | >1000 |
| 40 phr | 28.5 | −41.8 | 292 | 166.5 | 75.14 | 210.22 | 95.3 | 119.0 | 5.4 ± 0.7 | 1334 ± 87 |
| 50 phr | 33.3 | −40.1 | 291 | 164.8 | 81.23 | 198.44 | 18.9 | 120.5 | 7.4 ± 0.2 | 1213 ± 226 |
| 60 phr | 37.5 | −37.4 | 286 | 167.4 | 83.31 | 169.30 | 6.7 | 112.9 | 9.5 ± 0.4 | 1342 ± 132 |
| ACN- | 100 | 72.4 | 184 | 151.3 | 0 | — | — | — | — | — |
| Lignin | | | | | | | | | | |

^{a}Weight fraction of ACN-Lignin in the sample.
^{b}Glass transition temperature (T_{g}) from DSC thermogram curves.
^{c}Temperature corresponding to 5% mass loss.
^{d}Static heat resistant temperature (Tₛ) calculated from equation A1.
^{e} Gel content of the samples were measured by extraction with THF for 48 hrs at room temperature.
^{f}Activation energy calculated from Arrhenius plots for each sample.
^{g}Characteristic relaxation time (t*) at 210° C. obtained from stress relaxation plots.
^{h}Theoretical topology freezing temperature (Tᵥ) calculated by extrapolation for a viscosity of 10¹² Pa s.

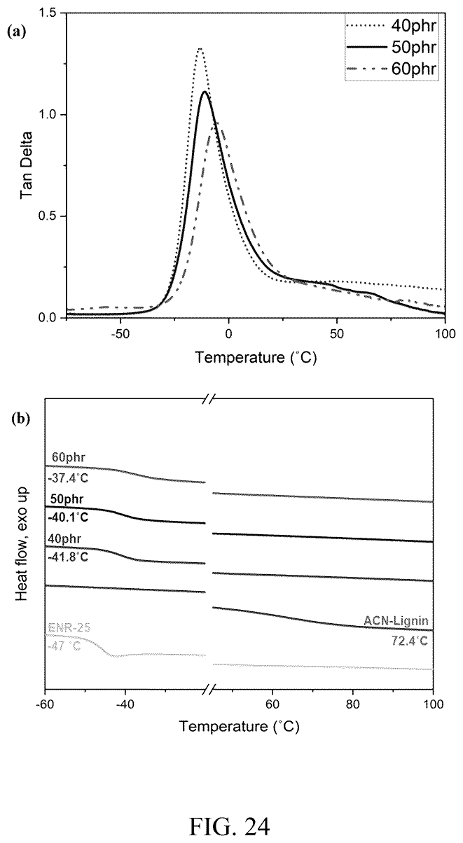

All of the lignin-derived vitrimeric elastomers exhibited excellent thermostability. The thermal degradation onset starting at 5% weight loss, from thermogravimetry data, was detected around 290° ° C. for 40-50 phr lignin loaded compositions (Table 1). Thermal degradation onset temperature (at 5% weight loss) dropped to 286° C. for composition with 60 phr lignin. The lignin-based vitrimeric compound presented here exhibits considerably higher thermal stability than the previously reported lignin-derived vitrimeric systems and thermoset materials that showed thermal degradation onset at 190°-220° C. (Moreno et al. ACS applied materials & interfaces, 2021, 13, 57952-57961 and Y. Xu, et al., ACS Sustainable Chemistry & Engineering, 2019, 7, 13456-13463). This suggests robust reprocessing potentials of ACN-Lignin/ENR25 compositions without significant material degradation. Dynamic mechanical analysis data, specifically, the peak temperature of loss tangent profile (tan 8) and DSC thermograms, revealed an enhancement in the T_{g} with higher lignin loading (FIG. 24). The lignin-derived vitrimer with higher lignin content (e.g., 70 phr) acts like a stiff and brittle plastic with an ultimate elongation at break of only ˜8%, however, with higher tensile strength of 15.1 MPa.

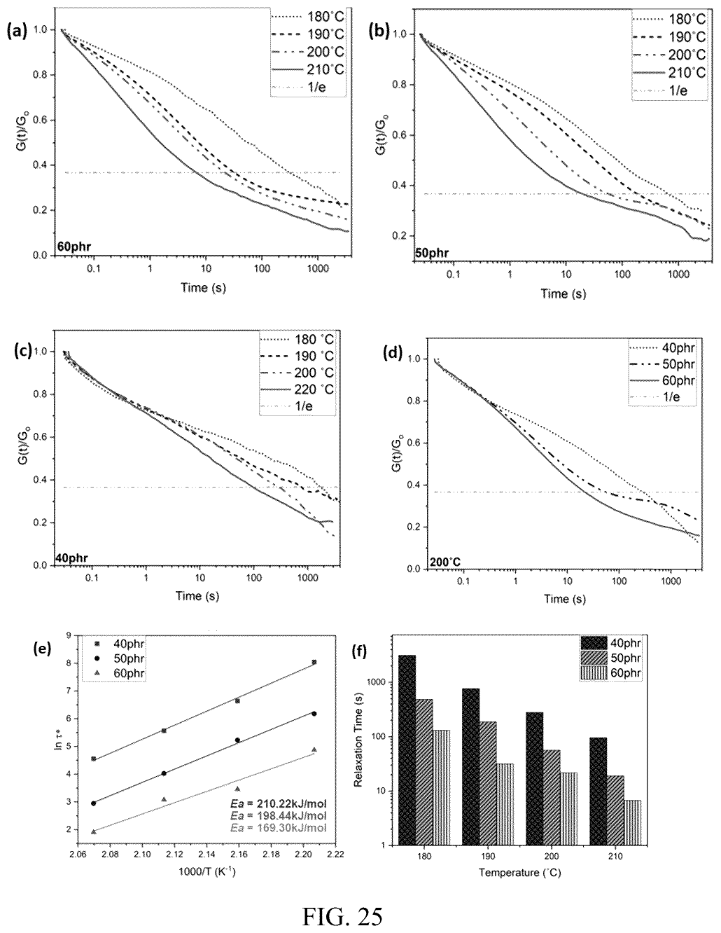

As schematically shown in FIG. 23, the crosslinking reaction between ACN-Lignin and ENR-25 yields ester and ether linkages along with β-hydroxy bonds. The β-hydroxy bonds further participate in TERs with adjacent ester linkages at elevated temperatures. In turn, these thermally stimulated TERs result in the topological rearrangement or dynamic bond exchange of the overall matrix resulting in changes in the viscoelastic properties of the vitrimer. Usually, thermal stress relaxation experiments assist in revealing the viscoelastic behavior of a vitrimer, where a constant external strain is applied to a sample and the stress response is followed as a function of time at different temperatures. Conventional thermosets with permanent crosslinks are not prone to any stress relaxation behavior under an externally applied strain. However, all the ACN-Lignin/ENR samples demonstrated an obvious stress relaxation trend, indicating vitrimeric behavior (see FIG. 25), which is attributed to the presence of TER-based covalent adaptive networks. The 60 phr composition (ACN-Lignin/ENR25=60/100), with the highest lignin content, showed the fastest relaxation rate with a τ* of a mere 6.7 s at 210° C. Typically, most bio-based vitrimeric systems exhibit longer relaxation times (>100 s), thereby limiting applications in continuous processing like extrusion and injection molding (T. Liu, et al, Macromolecules, 2017, 50, 8588-8597; Y. Li et al, Green Chemistry, 2020, 22, 870-881; S. Wang, et al., Macromolecules, 2018, 51, 8001-8012; S. Salach, et al., European Polymer Journal, 2021, 151, 110452), but are of interest for processing via compression molding.

Apart from the dynamic character of covalently adaptable networks, the macromolecular architecture and spatial orientation of bonds also play a crucial role in governing the exchange kinetics. The formation of hydroxyl bonds upon ring opening of epoxy due to the nucleophilic attack of carboxylic acid group from ACN-Lignin plays a pivotal role in the fast topological rearrangement. The presence of a hydroxyl nucleophile (β-hydroxy) in the vicinity of an ester moiety increases the likelihood of a productive exchange between the reaction partners, thus accelerating the exchange rate. Reducing the weight fraction of lignin in the system resulted in a slower relaxation rate of the system (FIG. 25). The 50 phr and 40 phr ACN-Lignin/ENR25 samples demonstrated τ* of 18.9 s and 95.3 s, respectively, at 210° C. This is likely due to decreased ester cross-linkages and unreacted carboxylic acid and alcoholic moieties, which result in lower site availability for effective chemical exchange within the system. The experimental relaxation times follow the Arrhenius law, allowing determination of the activation energy from the plots of In (τ*) against 1000/T (FIG. 25c). The activation energy for relaxation via topological rearrangement dropped from 210.22 KJ/mol to 169.30 KJ/mol upon increasing the lignin content from 40 phr to 60 phr, causing a faster relaxation (FIG. 25f). Furthermore, the theoretical topology freezing temperature (Tv) calculated by extrapolation for viscosity of 1012 Pa·s was observed to decrease with higher lignin content as well, indicating a faster topological rearrangement (Table 1).

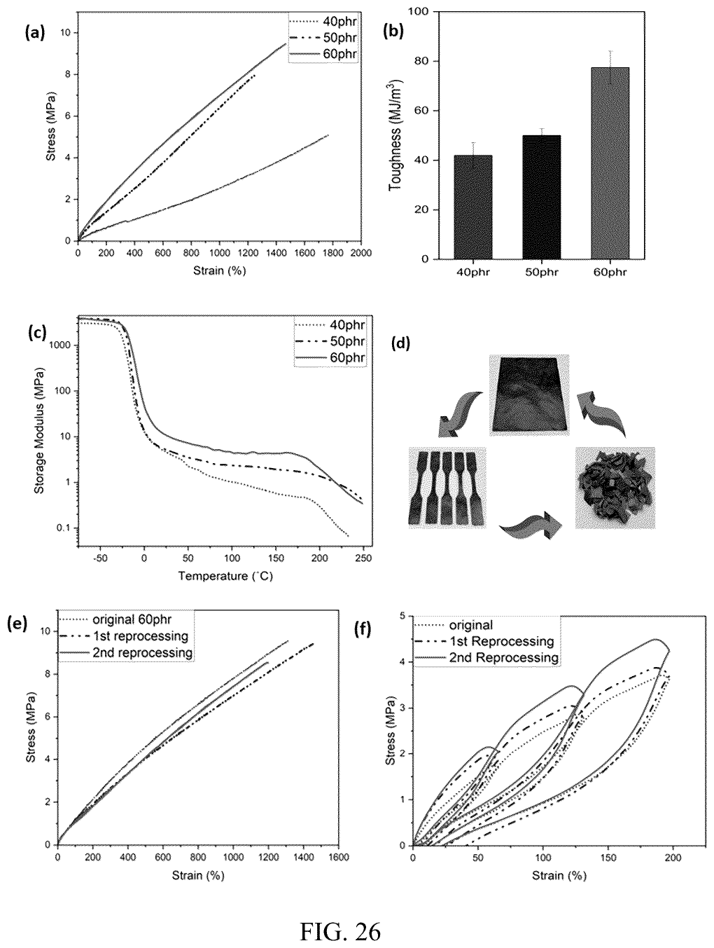

Mechanical properties play a crucial role in defining the suitable applications of a vitrimeric material. Tensile testing was used to examine the mechanical properties of all the Lignin-ENR vitrimers. The results are summarized in Table 1 and FIG. 26. The incorporation of higher mass fractions of highly branched aromatic lignin in the reaction mixture with inherently flexible ENR-25 segments markedly increased the tensile strength and toughness of the vitrimer. Of all compositions evaluated, 60 phr ACN-Lignin/ENR25 exhibited the highest tensile strength and toughness of 9.45 MPa and 77.5 MJ/m3 respectively, with an elongation at break at ˜1350% (FIGS. 26a and 26b). The 70 phr lignin containing vitrimer was stiff and brittle with an ultimate elongation at break of only ˜8%, however, with higher tensile strength of 15.1 MPa. Because of its very brittle nature, 70 phr lignin containing ENR-25 matrix composite was not further analyzed. The gradual increase in the tensile strength and toughness of the vitrimer upon increasing the lignin mass fraction can be attributed to the increase in the rigidity and crosslinking density of the vitrimer. Moreover, the innate three-dimensional phenylpropanoid backbone of lignin containing multifunctional groups offers reinforcing capabilities to the rubber matrix. This was further evidenced by a systematic increase in the storage modulus of the vitrimer on increased lignin loading. At the onset (40° C.) of the rubbery plateau range (40° C. to 180° C.), as depicted in FIG. 26c, the 60 phr ACN-Lignin/ENR25 vitrimer demonstrated a higher storage modulus (10.8 MPa) than the 50 phr (5.4 MPa) and 40 phr (4.8 MPa) vitrimer samples.

Furthermore, the presence of secondary alcohols, ethers and esters upon crosslinking are responsible for overall balance between hydrogen bonding acceptor and donor species in the material at any given time. The dynamic character of hydrogen bonding is instrumental in dissipating energy during force loading as it ruptures and reforms, thus contributing to increased toughness of the material, as demonstrated for various elastomeric and hydrogel systems (J. Sun et al, Nature, 2012, 489, 133-136). The stress relaxation/behavior induced by TERs at elevated temperatures is instrumental in imparting various sought-after properties like self-healing, shape-recovery and (re)processability. The reprocessed mechanically failed vitrimer samples demonstrated almost identical tensile properties as the original specimen even after two reprocessing cycles (FIG. 26c). The elastic recovery of the original and reprocessed vitrimer samples was investigated by applying a cyclic tension-retraction test for both original and reprocessed 60 phr vitrimer samples. Both original and reprocessed vitrimer samples exhibited exceptional elastic recovery with little energy dissipated (low hysteresis) during cyclic loading (FIG. 26f). The strong covalent interaction between rubber with low elastic modulus and lignin reinforcement with a high elastic modulus resulted in a material with high toughness and low hysteresis loss. Thus, this example also exhibits that addition of a rigid molecular building block to a soft rubbery matrix not only enhances structural robustness but also its high temperature relaxation rate or processability.

### Conclusions

Herein has been demonstrated the synthesis of a TER-based vitrimer by using 100% renewable biomass starting materials. The vitrimer was synthesized by reacting functional groups of ACN-Lignin and ENR25. The ACN fractionation of lignin received from pulp manufacturers resulted in a lignin with a narrower polydispersity and improved reactivity due to significant reduction in methoxy groups and around five-fold increase in the DS of carboxylic acid groups after extraction. A substantial increase in the T_{g}, modulus and tensile properties was observed upon increasing lignin content in the reaction mixture. The ester cross-linkages undergo dynamic exchange with nucleophilic hydroxyl and carboxylic acid groups from lignin at elevated temperatures, which allows the topological rearrangement of the crosslinked matrix, thereby enabling material to show thermal stress relaxation behavior. The rate of relaxation decreased with lower lignin content, which was evidenced by increase in relaxation times and activation energy for productive exchange. The material was observed to retain its tensile properties after multiple reprocessing cycles, suggesting its potential utilization in circular applications. By taking advantage of sustainable and affordable feedstocks, this approach introduces a facile method to synthesize fully bio-based vitrimeric elastomers for potential applications in both industrial development and frontier research.

While there have been shown and described what are at present considered the preferred embodiments of the invention, those skilled in the art may make various changes and modifications which remain within the scope of the invention defined by the appended claims.

What is claimed is:

1. A crosslinked polymeric composition comprising the following components:
(i) a matrix comprising an epoxy-anhydride crosslinked polymer containing a multiplicity of ester linkages resulting from reaction between epoxy-containing and anhydride-containing molecules; and
(ii) a hydroxy-containing solid filler component integrated into component (i) and engaged in dynamic reversible covalent crosslinking with component (i) by a reversible exchange reaction between the ester linkages and hydroxy groups in the hydroxy-containing solid filler; wherein the crosslinked polymeric composition behaves as a thermoset up to a temperature X and behaves as a processible thermoplastic at a temperature greater than X.

2. The crosslinked polymeric composition of claim 1, wherein the epoxy-containing molecules are selected from bisphenol A diglycidyl ether, poly(ethylene glycol) diglycidyl ether, and mixture thereof.

3. The crosslinked polymeric composition of claim 1, wherein the anhydride-containing molecules are monoanhydrides.

4. The crosslinked polymeric composition of claim 3, wherein the monoanhydrides are selected from the group consisting of methyl nadic anhydride (MNA), tetrahydrophthalic anhydride (THPA), methyl tetrahydrophthalic anhydride (MTHPA), methylhexahydrophthalic anhydride MHHPA), maleic anhydride (MAH), phthalic anhydride (PA), and mixtures of any of these.

5. The crosslinked polymeric composition of claim 1, wherein the anhydride-containing molecules are dianhydrides.

6. The crosslinked polymeric composition of claim 5, wherein the dianhydrides are selected from the group consisting of benzophenonetetracarboxylic dianhydride (BTDA), pyromellitic dianhydride (PMDA), 3,3′4,4′-biphenyltetracarboxylic acid dianhydride (BPDA), 4,4′-hexafluoroisopropylidenebisphthalic dianhydride (6FDA), 4,4′-oxydiphthalic anhydride (ODPA), 4,4′-(4,4′-isopropylidenediphenoxy)diphthalic anhydride (BPADA), perylenetetracarboxylic dianhydride, and mixtures of any of these.

7. The crosslinked polymeric composition of claim 1, wherein the hydroxy-containing solid filler component comprises biomass waste.

8. The crosslinked polymeric composition of claim 7, wherein the biomass waste is food waste.

9. The crosslinked polymeric composition of claim 8, wherein the food waste comprises spent coffee grounds.

10. The crosslinked polymeric composition of claim 1, wherein the hydroxy-containing solid filler component comprises lignocellulosic waste.

11. The crosslinked polymeric composition of claim 10, wherein the lignocellulosic waste is selected from the group consisting of wood, corn stover, corn husks, switchgrass, miscanthus, bagasse, bamboo, alfalfa, paper or cellulose pulp, paper waste, nut hulls, and hemp.

12. The crosslinked polymeric composition of claim 1, wherein the hydroxy-containing solid filler component comprises lignin.

13. The crosslinked polymeric composition of claim 1, wherein the hydroxy-containing solid filler component is present in an amount of 10-80 wt % of the crosslinked polymeric composition.

14. A method for producing a crosslinked polymeric composition, the method comprising combining and mixing the following components: (a) epoxy-containing molecules, (b) anhydride-containing molecules, (c) a hydroxy-containing solid filler, and (d) a catalyst that promotes curing between epoxy and anhydride groups, followed by heating of the resultant mixture to a temperature of least 100° ° C. for a period of time that results in curing and formation of the crosslinked polymeric composition, wherein the crosslinked polymeric composition behaves as a thermoset up to a temperature X and behaves as a processible thermoplastic at a temperature greater than X.

15. The method of claim 14, wherein the epoxy-containing molecules are selected from glycidylated bisphenol A, glycidylated poly(ethylene glycol), and mixture thereof.

16. The method of claim 14, wherein the anhydride-containing molecules are monoanhydrides.

17. The method of claim 16, wherein the monoanhydrides are selected from the group consisting of methyl nadic anhydride (MNA), tetrahydrophthalic anhydride (THPA), methyl tetrahydrophthalic anhydride (MTHPA), methylhexahydrophthalic anhydride MHHPA), maleic anhydride (MAH), phthalic anhydride (PA), and mixtures of any of these.

18. The method of claim 14, wherein the anhydride-containing molecules are dianhydrides.

19. The method of claim 18, wherein the dianhydrides are selected from the group consisting of benzophenonetetracarboxylic dianhydride (BTDA), pyromellitic dianhydride (PMDA), 3,3′4,4′-biphenyltetracarboxylic acid dianhydride (BPDA), 4,4′-hexafluoroisopropylidenebisphthalic dianhydride (6FDA), 4,4′-oxydiphthalic anhydride (ODPA), or 4,4′-(4,4′-isopropylidenediphenoxy)diphthalic anhydride (BPADA), perylenetetracarboxylic dianhydride, and mixtures of any of these.

20. The method of claim 14, wherein the hydroxy-containing solid filler component comprises biomass waste.

21. The method of claim 20, wherein the biomass waste is food waste.

22. The method of claim 21, wherein the food waste comprises spent coffee grounds.

23. The method of claim 14, wherein the hydroxy-containing solid filler component comprises lignocellulosic waste.

24. The method of claim 23, wherein the lignocellulosic waste is selected from the group consisting of wood, corn stover, corn husks, switchgrass, miscanthus, bagasse, bamboo, alfalfa, paper or cellulose pulp, nut hulls, and hemp.

25. The method of claim 14, wherein the hydroxy-containing solid filler component comprises lignin.

26. The method of claim 14, wherein the hydroxy-containing solid filler component is present in an amount of 10-80 wt % of the crosslinked polymeric composition.

27. The method of claim 14, wherein the epoxy-containing molecules and anhydride-containing molecules are present in a molar ratio of about 1:1.

28. The method of claim 14, wherein the mixture of epoxy-containing molecules and anhydride-containing molecules are impregnated into the hydroxy-containing solid filler component by a resin transfer molding process.

29. The method of claim 28, wherein the resin transfer molding process is a vacuum assisted resin transfer molding process.
